(19) United States
(12) Patent Application Publication
(10) Pub. No.: US 2024/0337721 A1
(43) Pub. Date: Oct. 10, 2024

(54) DATA COLLECTION AND TRAINING FOR A NETWORK POSITIONING MODEL

(71) Applicant: QUALCOMM Incorporated, San Diego, CA (US)

(72) Inventors: Mohammed Ali Mohammed HIRZALLAH, San Diego, CA (US); Srinivas YERRAMALLI, San Diego, CA (US); Taesang YOO, San Diego, CA (US)

(21) Appl. No.: 18/295,817

(22) Filed: Apr. 4, 2023

(51) Int. Cl. G01S 5/02; H04L 5/00; H04W 64/00

(52) U.S. Cl. CPC G01S 5/02524; G01S 5/0236; H04L 5/0048; H04W 64/00

(57) ABSTRACT

A network node may receive a set of sounding reference signals (SRSs) from a wireless device. The network node may measure the set of SRSs. The network node may output at least one of a set of estimated positioning labels, training associated information, or labeling assistance information associated with the set of measured SRSs for a positioning model. In one example, the network node may output the data by training the positioning model based on at least one of the set of estimated positioning labels, the training associated information, the labeling assistance information, or the set of measured SRSs. In another example, the network node may output the data by transmitting, for a network entity, at least one of the set of estimated positioning labels, the training associated information, or the set of measured SRSs for training the positioning model.

### TECHNICAL FIELD

The present disclosure relates generally to communication systems, and more particularly, to a system for performing positioning for a wireless device.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a network node. The network node may include a base station or a transmission reception point (TRP). The apparatus may receive a set of sounding reference signals (SRSs) from a wireless device. The apparatus may measure the set of SRSs. The apparatus may output at least one of a set of estimated positioning labels, training associated information, or labeling assistance information associated with the set of measured SRSs for a positioning model. The apparatus may output at least one of the set of estimated positioning labels, the training associated information, or the labeling assistance information by training the positioning model based on at least one of the set of estimated positioning labels, the training associated information, the labeling assistance information, or the set of measured SRSs. The apparatus may output at least one of the set of estimated positioning labels, the training associated information, or the labeling assistance information by transmitting, for a network entity, at least one of the set of estimated positioning labels, the training associated information, or the set of measured SRSs for training the positioning model.

In an aspect of the disclosure, a method, a computer-readable medium, and an apparatus are provided. The apparatus may include a network entity. The network entity may include a location management function (LMF) or a set of location servers. The apparatus may transmit a configuration for a set of SRSs from a wireless device to a network node. The apparatus may receive at least one of a set of measured SRSs, a first set of estimated positioning labels, or training associated information associated with the set of SRSs. The apparatus may output at least one of a second set of estimated positioning labels, labeling assistance information, the set of measured SRSs, or the training associated information associated with the set of SRSs for a positioning model. The apparatus may output at least one of the second set of estimated positioning labels, the labeling assistance information, the set of measured SRSs, or the training associated information by training the positioning model based on at least one of the second set of estimated positioning labels, the labeling assistance information, the set of measured SRSs, or the training associated information. The apparatus may output at least one of the second set of estimated positioning labels, the labeling assistance information, the set of measured SRSs, or the training associated information by transmitting, for the network node, at least one of the second set of estimated positioning labels or the labeling assistance information for training the positioning model.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of positioning based on reference signal measurements.

FIG. 5 is a diagram illustrating an example of a network entity coordinating a plurality of base stations to perform positioning with a wireless device.

FIG. 6 is a connection flow diagram illustrating an example of communications between a positioning target wireless device, a set of positioning neighbor wireless devices, and a positioning network entity configured to train a positioning model.

FIG. 7 is a connection flow diagram illustrating an example of communications between a positioning target wireless device, a set of positioning neighbor wireless devices, and a positioning network entity configured to train a positioning model.

FIG. 8 is a flowchart of a method of wireless communication.

FIG. 9 is a flowchart of a method of wireless communication.

FIG. 10 is a diagram illustrating an example of a hardware implementation for an example network entity.

FIG. 11 is a diagram illustrating an example of a hardware implementation for an example network entity.

### DETAILED DESCRIPTION

Various aspects relate generally to performing positioning using a system of wireless devices. Some aspects more specifically relate to performing positioning using radio frequency (RF) signals. Other aspects more specifically relate to performing positioning using a positioning model generated using training data. In some examples, a wireless device, for example a user equipment (UE) or a positioning reference unit (PRU) may transmit a set of uplink positioning signals (e.g., sounding reference signals (SRSs)) to a set of wireless devices, for example a set of network nodes or a set of transmission reception points (TRPs).

In some aspects, a positioning model may be used to calculate one or more positioning metrics, for example a location of the wireless device transmitting uplink positioning signals or an intermediate measurement that may be used to calculate the location of the wireless device. A positioning model may be generated using artificial intelligence (AI)/machine learning (ML) (AI/ML or AIML), using a set of inputs (e.g., measurements of positioning signals, assistance information associated with the positioning signals) and a set of labels. A label may be a calculated expected result associated with a set of inputs. The label may be, for example, a location of the wireless device transmitting uplink positioning signals or an intermediate measurement (e.g., a timing measurement, an angle measurement, a line-of-sight (LOS) identification) that may be used to calculate the location of the wireless device. The positioning model may be repeatedly trained using AI/ML using a set of inputs and a set of expected labels until the positioning model may reliably calculate a result (e.g., a location of the wireless device, an intermediate measurement that may be used to calculate the location of the wireless device) based on a set of inputs. In other words, a set of inputs and a set of labels may be used for generating and/or training a positioning model using AI/ML.

When training a positioning model, the set of inputs may include measurements based on uplink signals from the wireless device, such as SRSs. The training data may include reference signal measurements, clean or noisy labels (clean labels may have a quality metric greater or equal to a threshold, noisy labels may have a quality metric less than or equal to the threshold), and training data assistance information. The assistance information may include, for example, a bandwidth part (BWP) used for a PRS, a number of TRPs receiving sets of SRSs from the wireless device, beam information, and/or SRS configuration information. However, some network nodes may not support signaling for collecting training data to train positioning models based on measurements taken of uplink reference signals. Some network nodes may also not support transmitting training data assistance information due to privacy limitations (e.g., a base station may not be configured to transmit its location or beam information to a base station or TRP of another manufacturer or vendor). In some aspects, network nodes or network entities may be configured to report a set of estimated positioning labels, training associated information, and/or labeling assistance information associated with a set of measured SRSs to one another for training a positioning model. Training associated information may include training data assistance information that a network node, such as a node that receives uplink positioning signals from a wireless device, may transmit to a network entity for the network entity to train a positioning model. Labeling assistance information may include training data assistance information that a network entity may transmit to a network node that receives uplink positioning signals from a wireless device for the network node to train a positioning model.

In some aspects, a network node may receive a set of SRSs from a wireless device. The network node may measure the set of SRSs. The network node may output at least one of a set of estimated positioning labels, training associated information, or labeling assistance information associated with the set of measured SRSs for a positioning model. The network node may output at least one of the set of estimated positioning labels, the training associated information, or the labeling assistance information by training the positioning model based on at least one of the set of estimated positioning labels, the training associated information, the labeling assistance information, or the set of measured SRSs. The network node may output at least one of the set of estimated positioning labels, the training associated information, or the labeling assistance information by transmitting, for a network entity, at least one of the set of estimated positioning labels, the training associated information, or the set of measured SRSs for training the positioning model.

In some aspects, a network entity may transmit a configuration for a set of SRSs from a wireless device to a network node. The network entity may receive at least one of a set of measured SRSs, a first set of estimated positioning labels, or training associated information associated with the set of SRSs. The network entity may output at least one of a second set of estimated positioning labels, labeling assistance information, the set of measured SRSs, or the training associated information associated with the set of SRSs for a positioning model. The network entity may output at least one of the second set of estimated positioning labels, the labeling assistance information, the set of measured SRSs, or the training associated information by training the positioning model based on at least one of the second set of estimated positioning labels, the labeling assistance information, the set of measured SRSs, or the training associated information. The network entity may output at least one of the second set of estimated positioning labels, the labeling assistance information, the set of measured SRSs, or the training associated information by transmitting, for the network node, at least one of the second set of estimated positioning labels or the labeling assistance information for training the positioning model.

In some aspects, the entities for collecting data for training a network-side positioning model (e.g., an AI/ML model) may include network nodes, such as a TRP, a next generation node B (gNB), or a next generation radio access network (NG-RAN) node.

In some aspects, the collected training data may include uplink-based (UL-based) basic measurements received and measured by a network node, such as reference signal time difference (RSTD) measurements, reference signal received power (RSRP) measurements, reference signal received power path (RSRPP) measurements, angle of arrival (AoA) measurements, and/or line-of-sight (LOS) identification measurements. In some aspects, the collected training data may include UL-based enhanced measurements received and measured by a network node, such as soft information (e.g., likelihood, probability, range, or distribution) of RSTD measurements, soft information of RSRP measurements, soft information of RSRPP measurements, soft information of AoD measurements, additional path reporting, beam path information, LOS phase information, additional beam path phase information, and/or a joint composition of UL-based basic measurements. In some aspects, the collected training data may include UL-based novel measurements received and measured by a network node, such as channel impulse response (CIR) measurements, channel frequency response (CFR) measurements, and/or power delay profile (PDP) measurements. In some aspects, labels for training a network-side positioning model may be obtained based on a known PRU location, a location of a UE obtained using a non-radio access technology (non-RAT) method, a location of a UE derived by an LMF, and/or intermediate labels (labels used to calculate a location of the wireless device) derived by an LMF. The LMF may derive/calculate a location of the UE or the intermediate labels associated with the location of the UE based on reported measurements and/or labels from any positioning wireless devices, including the UE, surrounding UEs, PRUs, and/or network nodes (e.g., TRPs, gNBs). In some aspects, where a network node (e.g., an NG-RAN node) may assist with positioning in a scenario with a positioning model on a network device, an LMF may provide additional assistance information when providing labeling assistance to a network node. The assistance information may include an indication of reference signal resources, with enhanced timestamping in some aspects, used to obtain intermediate labels using RAT methods. In some aspects, a network node (e.g., gNB/TRP) may provide additional assistance information to the LMF. The assistance information may include reference signal resources, with enhanced timestamping in some aspects, used by the network node to derive the measurements (which may include intermediate measurements) and/or TRP proprietary information. In some aspects, an NG-RAN node may request an LMF to assist in collecting training data as part of a new radio (NR) positioning protocol (NRPP) annex (NRPPa) framework for NG-RAN node assisted positioning with a positioning model at a network node. In some aspects, an LMF node may request an NG-RAN node to assist in collecting training data as part of an NRPPa framework for NG-RAN node assisted positioning with a positioning model at an LMF. Such training data may be collected as a part of basic positioning techniques, and/or positioning techniques dedicated towards training data. In some aspects, training data collection sessions for a positioning model between an LMF and an NG-RAN node may be initiated by an NG-RAN node initiated or initiated by an LMF. The initiation of the training data collection session may be initiated by at least one of a session capability exchange, a session configuration exchange, a session initiation message, a session error message, a session pause message, and/or a session termination message. In some aspects, in an NG-RAN node initiated data collection scenario, the NG-RAN node may request LMF to provide its capability to assist in training data collection and labelling assistance, the LMF may indicate its capability to assist, and the NG-RAN node may provide the LMF with requested UL reference signal configurations, periodicity of label assistance reporting, and/or whether the LMF should report any enhanced timing or resource indicators. The LMF may provide labels back to the requesting NG-RAN node according to the requested periodicity and configuration. In some aspects, the LMF may also provide additional meta data. In some aspects, in an LMF initiated data collection scenario, the LMF may request the NG-RAN node to provide its capability to assist in training data collection and labelling assistance, the NG-RAN node may indicate its capability to assist, and the LMF may provide the NG-RAN node with requested UL reference signal configurations, periodicity of label assistance reporting, and/or whether the NG-RAN node should report any enhanced timing or resource indicators. The NG-RAN node may provide labels back to the requesting LMF according to the requested periodicity and configuration. In some aspects, the NG-RAN node may also provide additional meta data.

Particular aspects of the subject matter described in this disclosure may be implemented to realize one or more of the following potential advantages. In some examples, by enabling network nodes and network entities to exchange sets of estimated positioning labels, training associated information, and/or labeling assistance information associated with a set of SRSs, the described techniques can be used to train a positioning model at a network.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

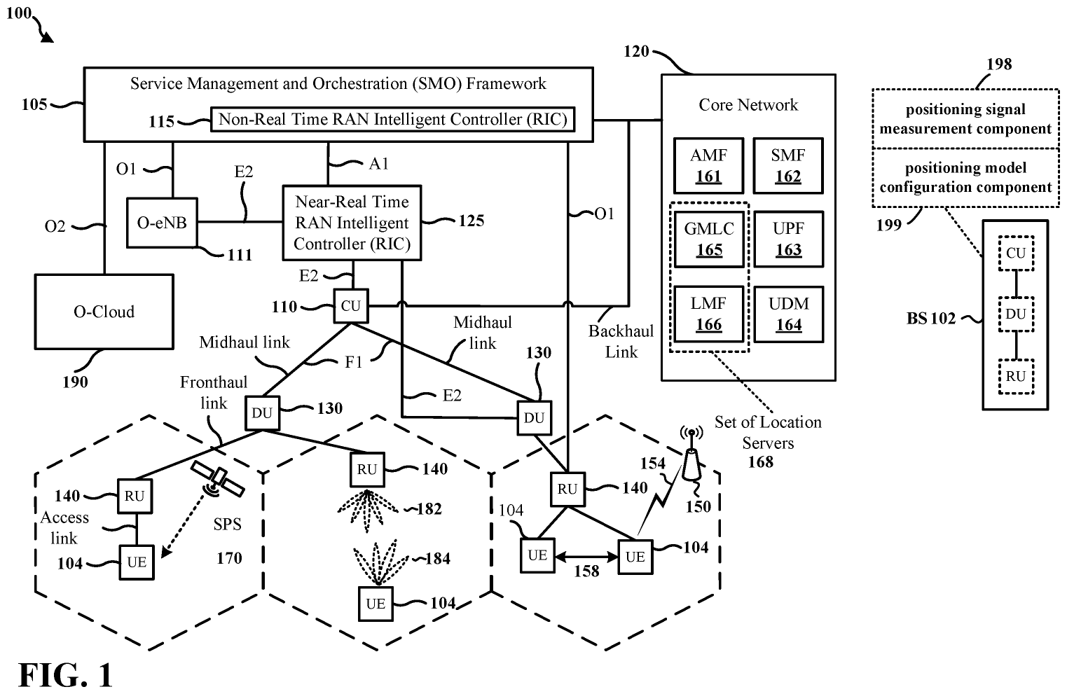

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 102 may have a positioning signal measurement component 198 that may be configured to receive a set of sounding reference signals (SRSs) from a wireless device, such as the UE 104. The positioning signal measurement component 198 may be configured to measure the set of SRSs. The positioning signal measurement component 198 may be configured to output at least one of a set of estimated positioning labels, training associated information, or labeling assistance information associated with the set of measured SRSs for a positioning model. In certain aspects, the base station 102 may have a positioning model configuration component 199 that may be configured to transmit a configuration for a set of SRSs from a wireless device, such as the UE 104, to a network node, such as another base station 102. The base station 102 that has the positioning model configuration component 199 may include the LMF 166 and/or the one or more location servers 168. The positioning model configuration component 199 may be configured to receive at least one of a set of measured SRSs, a first set of estimated positioning labels, or training associated information associated with the set of SRSs. The positioning model configuration component 199 may be configured to output at least one of a second set of estimated positioning labels, labeling assistance information, the set of measured SRSs, or the training associated information associated with the set of SRSs for a positioning model. The positioning model configuration component 199 may configure a set of positioning signals, such as sets of SRSs, to be received and measured by the positioning signal measurement component 198. One of the positioning signal measurement component 198 or the positioning model configuration component 199 may be configured to train a positioning model based on a set of estimated positioning labels, training associated information, labeling assistance information, and/or the measured set of SRSs. The other of the positioning signal measurement component 198 or the positioning model configuration component 199 may be configured to transmit at least some of the set of estimated positioning labels, training associated information, labeling assistance information, and/or the measured set of SRSs to the component training the positioning model.

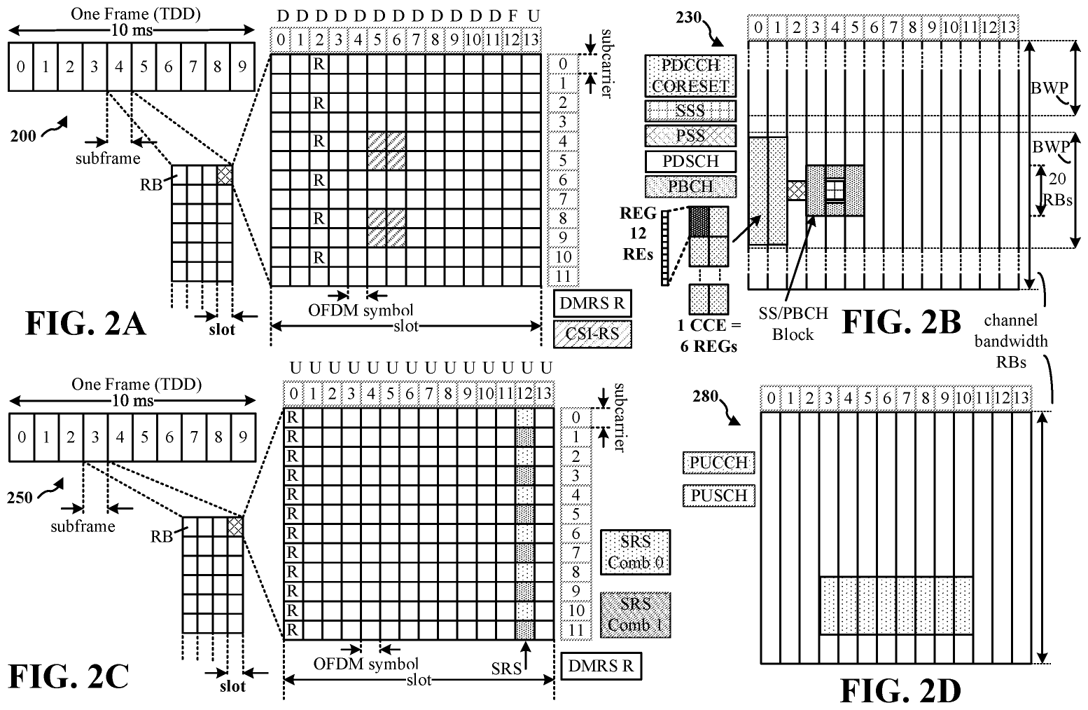

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2″ slots/subframe. The subcarrier spacing may be equal to 24^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

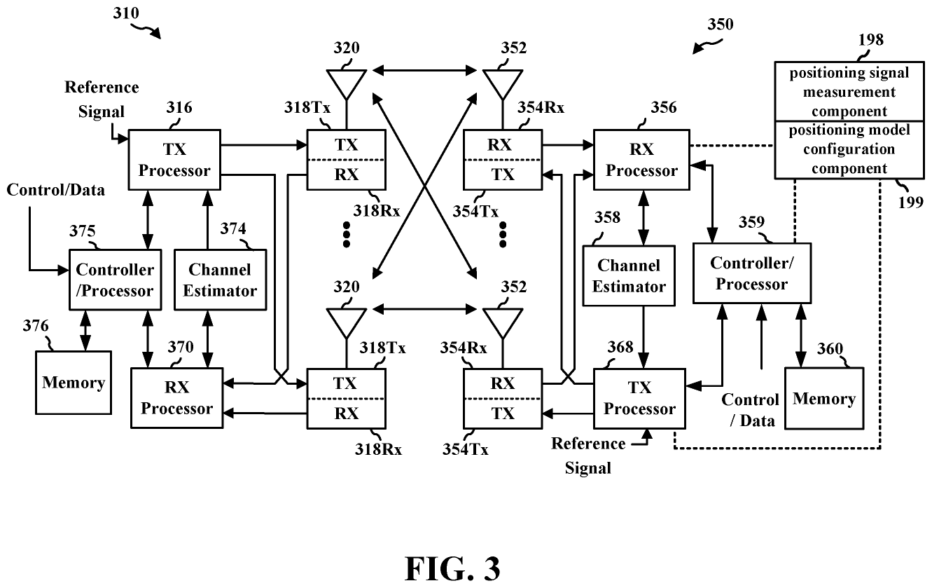

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the positioning signal measurement component 198 of FIG. 1.

At least one of the TX processor 316, the RX processor 370, and the controller/processor 375 may be configured to perform aspects in connection with the positioning model configuration component 199 of FIG. 1.

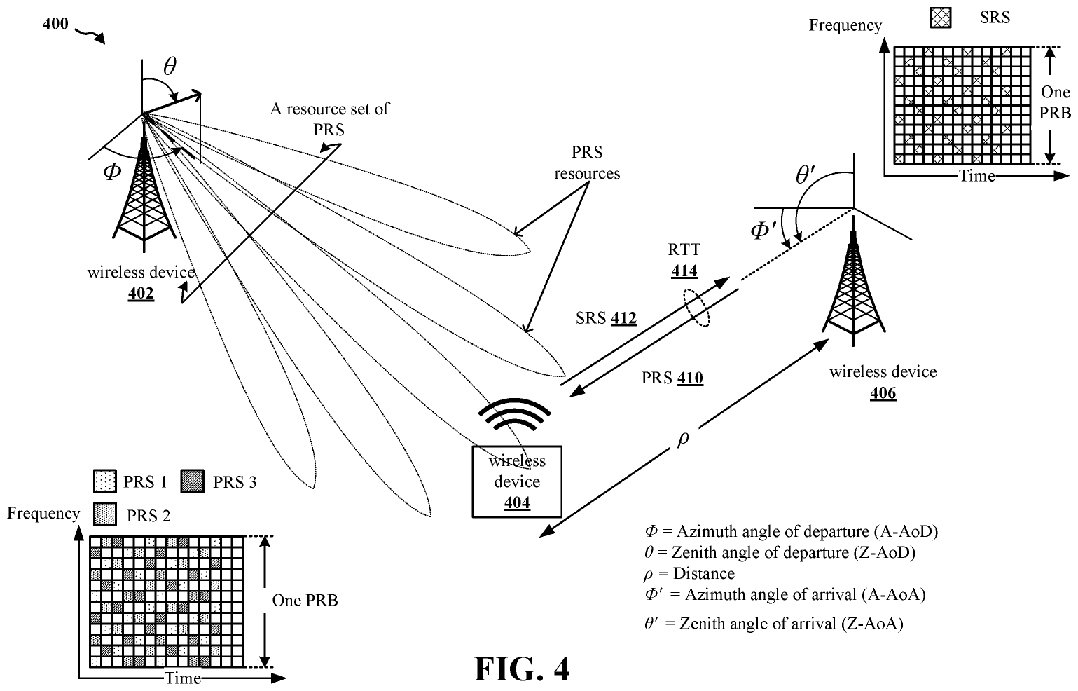

FIG. 4 is a diagram 400 illustrating an example of positioning based on reference signal measurements. The wireless device 402 may be a UE, a base station, or a positioning reference unit (PRU). The wireless device 404 may be a UE, a base station, or a PRU. The wireless device 406 may be a UE, a base station, or a PRU. The wireless device 402 may be referred to as a positioning target wireless device, whose location may be calculated based on measurements of one or more reference signals. The wireless device 404 and the wireless device 406 may be referred to as positioning neighbor wireless devices, whose locations may be known, which may be used to calculate the location of the wireless device 402. The wireless device 404 may transmit SRS 412 at time T_{SRS_TX} to the wireless device 406. The wireless device 404 may receive positioning reference signals (PRS) 410 at time T_{PRS_RX} from the wireless device 406. The SRS 412 may be an UL-SRS. The PRS 410 may be a DL-PRS. In some aspects, the wireless device 402 may be a TRP and the wireless device 406 may be a TRP, which may be both configured to transmit DL-PRS to the wireless device 404. The wireless device 404 may be a UE configured to transmit UL-SRS to the wireless device 402 and the wireless device 406.

The wireless device 406 may receive the SRS 412 at time T_{SRS_RX} from the wireless device 404 and transmit the PRS 410 at time T_{PRS_TX} to the wireless device 404. The wireless device 404 may receive the PRS 410 before transmitting the SRS 412. The wireless device 404 may transmit the SRS 412 before receiving the PRS 410. The wireless device 404 may transmit the SRS 412 in response to receiving the PRS 410. The wireless device 406 may transmit the PRS 410 in response to receiving the SRS 412. A positioning server (e.g., location server(s) 168), the wireless device 404, or the wireless device 406 may determine the round-trip-time (RTT) 414 based on ∥T_{SRS_RX}−T_{PRS_TX}|−|T_{SRS_TX}−T_{PRS_RX}∥. Multi-RTT positioning may make use of the Rx−Tx time difference measurements (i.e., |T_{SRS_TX}−T_{PRS_RX}|) and PRS reference signal received power (RSRP) (PRS-RSRP) of PRS signals received from multiple wireless devices, such as the wireless device 402 and the wireless device 406, which are measured by the wireless device 404, and the measured Rx−Tx time difference measurements (i.e., |T_{SRS_RX}−T_{PRS_TX}|) and SRS-RSRP at multiple wireless devices, such as at the wireless device 402 and at the wireless device 406 of SRS transmitted from wireless device 404. The wireless device 404 may measure the Rx−Tx time difference measurements, and/or PRS-RSRP of the received signals, using assistance data received from the positioning server, the wireless device 402, and/or the wireless device 406. The wireless device 402 and the wireless device 406 may measure the Rx−Tx time difference measurements, and/or SRS-RSRP of the received signals, using assistance data received from the positioning server. The measurements may be used at the positioning server or the wireless device 404 to determine the RTT, which may be used to estimate the location of the wireless device 404. Other methods are possible for determining the RTT, such as for example using time-difference of arrival (TDOA) measurements, such as DL-TDOA and/or UL-TDOA measurements.

DL-AoD positioning may make use of the measured PRS-RSRP of signals transmitted from multiple wireless devices, such as the wireless device 402 and the wireless device 406, and received at the wireless device 404. The AoD positioning may also be referred to as DL-AoD positioning where the PRS are DL signals. The wireless device 404 may measure the PRS-RSRP of the received signals using assistance data received from the positioning server, and the resulting measurements may be used along with the azimuth angle of departure (A-AoD), the zenith angle of departure (Z-AoD), and other configuration information to locate the wireless device 404 in relation to the neighboring wireless devices that transmitted the PRS, such as the wireless device 402 and the wireless device 406.

DL-TDOA positioning may make use of the DL reference signal time difference (RSTD), and/or PRS-RSRP of signals received from multiple wireless devices, such as the wireless device 402 and the wireless device 406, at the wireless device 404. The wireless device 404 may measure the RSTD, and/or the PRS-RSRP, of the received PRS signals using assistance data received from the positioning server, and the resulting measurements may be used along with other configuration information to locate the wireless device 404 in relation to the neighboring wireless devices that transmitted the PRS, such as the wireless device 402 and the wireless device 406.

UL-TDOA positioning may make use of the UL relative time of arrival (RTOA), and/or SRS-RSRP, at multiple wireless devices, such as the wireless device 402 and the wireless device 406, of signals transmitted from the wireless device 404. The wireless devices, such as the wireless device 402 and the wireless device 406, may measure the RTOA, and/or the SRS-RSRP, of the received signals using assistance data received from the positioning server, and the resulting measurements may be used along with other configuration information to estimate the location of the wireless device 404.

UL-AoA positioning may make use of the measured azimuth angle of arrival (A-AoA) and zenith angle of arrival (Z-AoA) at multiple wireless devices, such as the wireless device 402 and the wireless device 406, of signals transmitted from the wireless device 404. The wireless device 402 and the wireless device 406 may measure the A-AoA and the Z-AoA of the received signals using assistance data received from the positioning server, and the resulting measurements may be used along with other configuration information to estimate the location of the wireless device 404.

Additional positioning methods may be used for estimating the location of the wireless device 404, such as for example, UL-AoD and/or DL-AoA at the wireless device 404. Note that data/measurements from various technologies may be combined in various ways to increase accuracy, to determine and/or to enhance certainty, to supplement/complement measurements, and/or to substitute/provide for missing information.

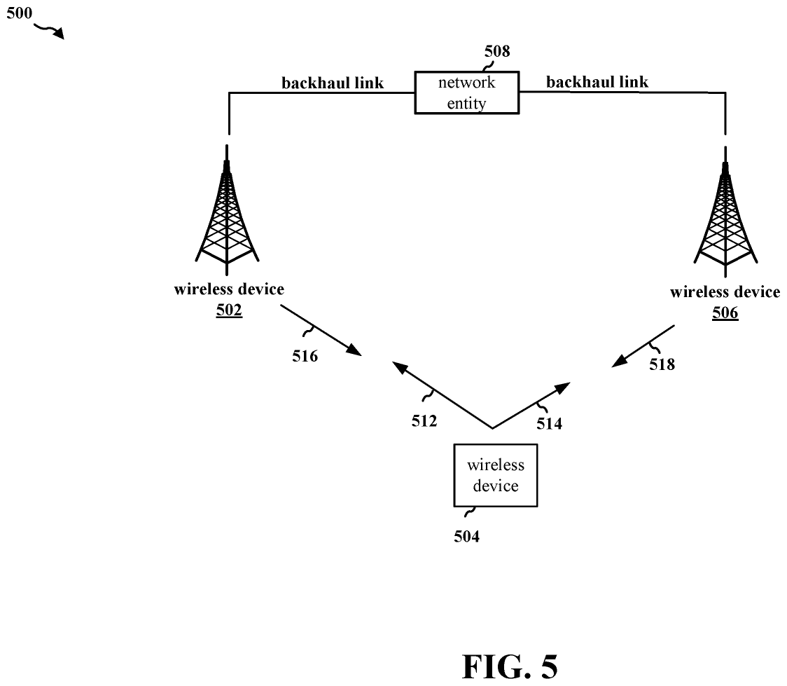

FIG. 5 is a diagram 500 illustrating a network entity 508 that may be configured to coordinate a wireless device 502 and a wireless device 506 to perform positioning with a wireless device 504. The location of the wireless device 502 and the wireless device 506 may be known. The wireless device 502 may be a base station or a TRP. The wireless device 506 may be a base station or a TRP. The wireless device 504 may be a UE or a PRU. The network entity 508 may be connected to the wireless device 502 and the wireless device 506 via a physical link, for example a backhaul link or a midhaul link. The network entity 508 may be an LMF or a set of location servers.

To perform positioning, the network entity 508 may configure the wireless devices to transmit positioning signals at one another. For example, the wireless device 504 may transmit the set of positioning signals 512 at the wireless device 502 The set of positioning signals 512 may be a set of SRSs. The wireless device 502 may transmit the set of positioning signals 516 at the wireless device 504. The set of positioning signals 516 may be a set of PRSs. The wireless device 504 may transmit a set of positioning signals 514 at the wireless device 506. The set of positioning signals 514 may be a set of SRSs. The wireless device 506 may transmit a set of positioning signals 518 at the wireless device 504. The set of positioning signals 518 may be a set of PRSs. One or more of the wireless devices may measure the received positioning signals to calculate a positioning measurement that may be used to calculate a location of the wireless device 504, or may be used to calculate a position or a location of the wireless device 504. For example, if the location of the wireless device 502 and the location of the wireless device 506 are known, the location of the wireless device 504 may be calculated based on a RTT between the wireless device 502 and the wireless device 504, and a RTT between the wireless device 504 and the wireless device 506. In another example, the wireless device 504 may calculate an angle of arrival (AoA) or an angle of departure (AoD) of the set of positioning signals 516, and may calculate an AoA or an AoD of the set of positioning signals 518. The calculated AoAs and/or AoDs may be used to calculate a position of the wireless device 504 if the location of the wireless device 502 and the location of the wireless device 506 are also known.

In some aspects, a positioning model may be used to calculate one or more positioning metrics, for example a location of the wireless device 504 or an intermediate measurement that may be used to calculate the location of the wireless device 504. A positioning model may be generated using artificial intelligence (AI)/machine learning (ML) (AI/ML or AIML), using a set of inputs (e.g., measurements of positioning signals, assistance information associated with the positioning signals) and a set of labels. A label may be a calculated expected result associated with a set of inputs. The label may be, for example, a location of a wireless device 504 or an intermediate measurement (e.g., a timing measurement, an angle measurement, a LOS identification) that may be used to calculate the location of the wireless device 504. The positioning model may be repeatedly trained using AI/ML using a set of inputs and a set of expected labels until the positioning model may reliably calculate a result (e.g., a location of the wireless device 504, an intermediate measurement that may be used to calculate the location of the wireless device 504) based on a set of inputs. In other words, a set of inputs and a set of labels may be used for generating and/or training a positioning model using AI/ML.

When training a positioning model, the set of inputs may include measurements based on uplink signals from the wireless device, such as SRSs. The training data may include reference signal measurements, clean or noisy labels (clean labels may have a quality metric greater or equal to a threshold, noisy labels may have a quality metric less than or equal to the threshold), and training data assistance information. The assistance information may include, for example, a BWP used for a PRS, a number of TRPs receiving sets of SRSs from the wireless device, beam information, and/or SRS configuration information. However, some network nodes may not support signaling for collecting training data to train positioning models based on measurements taken of uplink reference signals. Some network nodes may also not support transmitting training data assistance information due to privacy limitations (e.g., a base station may not be configured to transmit its location or beam information to a base station or TRP of another manufacturer or vendor). In some aspects, network nodes or network entities may be configured to report a set of estimated positioning labels, training associated information, and/or labeling assistance information associated with a set of measured SRSs to one another for training a positioning model. Training associated information may include training data assistance information that a network node, such as a node that receives uplink positioning signals from a wireless device, may transmit to a network entity for the network entity to train a positioning model. Labeling assistance information may include training data assistance information that a network entity may transmit to a network node that receives uplink positioning signals from a wireless device for the network node to train a positioning model.

In one aspect, a system may be configured to train a positioning model at a network node that receives uplink positioning signals, for example the wireless device 502 that receives the set of positioning signals 512 from the wireless device 504. For example, the wireless device 502 may have a positioning model configured to calculate a set of intermediate measurements that may be used to calculate a position of the wireless device 504 based on a set of inputs. The label training data of the intermediate measurements may be referred to as the set of estimated positioning labels (i.e., the estimated idealized outputs for the positioning model to calculate). The set of inputs may be a set of measurements taken at the wireless device 502 of the set of positioning signals 512 from the wireless device 504. The measurements may include, for example, at least one of (a) a relative time of arrival (RTOA) (e.g., relative time for a set of positioning signals 512 to be received by the wireless device 502 vs. the wireless device 506), (b) a reference signal received power (RSRP) (e.g., a power of the set of positioning signals 512), (c) a reference signal received path power (RSRPP) (e.g., a power of a set of positioning signals transmitted along a first path vs. a second path), (d) an angle of arrival (AoA), (e) a line-of-sight (LOS) identification (e.g., whether there is a direct LOS path between the wireless device 504 and the wireless device 502), (f) a probability of the RTOA (e.g., a percent likelihood that the measured RTOA is the actual RTOA value), (g) a probability of the RSRP. (h) a probability of the RSRPP. (i) a probability of the AoA, (j) a range of the RTOA (e.g., estimated min/max values of the RTOA, within a tolerance level), (k) a range of the RSRP, (l) a range of the RSRPP. (m) a range of the AoA, (n) a channel impulse response (CIR), (o) a channel frequency response (CFR), and/or (p) a power delay profile (PDP). The set of estimated positioning labels may include, for example, at least one of (a) an RTOA. (b) an RSRP, (c) an RSRPP. (d) an AoA. (c) an LOS identification, (f) a probability of the RTOA, (g) a probability of the RSRP. (h) a probability of the RSRPP. (i) a probability of the AoA. (j) a range of the RTOA, (k) a range of the RSRP. (l) a range of the RSRPP. (m) a range of the AoA. (n) a CIR (the CIR may be a compressed version if it is used as a label, and an uncompressed version if it is used as a measurement input), (o) a CFR, (p) a PDP. (q) an indication of a location of the wireless device 504, and/or (r) a ToA. While the theoretical set of input measurements and the theoretical set of output labels may include the same set of measurements, an actual positioning model being trained may be configured to not have the same set of measurements used as both the input measurements and the output labels used for training, as such a positioning model may be impractical for use (i.e., there are few reasons for someone to use an RSRP of a set of positioning signals to calculate the RSRP of the set of positioning signals). It is more practical for the set of input measurements and the set of output labels to be non-overlapping.

The wireless device 502 may train the positioning model based on a calculated location of the wireless device 504 and a set of inputs, such as measurements of the set of positioning signals 512 received at the wireless device 502, measurements of the set of positioning signals 514 received at the wireless device 506, intermediate measurements calculated at the wireless device 504, intermediate measurements calculated at the wireless device 502, intermediate measurements calculated at the wireless device 506, intermediate measurements calculated at the network entity 508, training associated information associated with the set of positioning signals 516 or the set of positioning signals 512 at the wireless device 502, training associated information associated with the set of positioning signals 518 or the set of positioning signals 514 at the wireless device 506, and/or labeling assistance information associated with the set of positioning signals 516, the set of positioning signals 512, the set of positioning signals 518, or the set of positioning signals 514 at the network entity 508. The training associated information may include at least one of (a) a frame number, (b) a slot index, (c) an orthogonal frequency-division multiplexing (OFDM) symbol, (d) a hyper frame number, (c) an indication of a coordinated universal time (UTC) timing, (f) an indication of a location of a network node (e.g., the location of the wireless device 502 and/or the wireless device 506), (g) an indication of a location of a TRP (e.g., the location of the wireless device 502 and/or the wireless device 506, (h) an indication of an implementation error (e.g., synchronization errors at a wireless device, timing errors at a wireless device), (i) a resource mapping (e.g., a mapping between a resource and a location of a wireless device associated with transmitting or receiving the resource), (j) an indication of a label quality (e.g., whether a label is clean or dirty, compared to a threshold quality level), (k) an indication of a quality associated with a measurement of a positioning signal, and/or (l) a beam angle (e.g., AoA or AoD). The labeling assistance information may include at least one of (a) a frame number, (b) a slot index, (c) an OFDM symbol, (d) a hyper frame number, or (c) an indication of a UTC timing. The location of the wireless device 504 may be calculated in a plurality of ways to train the positioning model. For example, the network entity 508 may receive measurements from the wireless device 502, the wireless device 506, and the wireless device 504 and may calculate a position of the wireless device 504, or the wireless device 504 may calculate its position using a set of signals received by a LIDAR device, a GNSS device, or a WLAN antenna. After the positioning model is trained, the wireless device 504 may transmit the set of positioning signals 512 at the wireless device 502 and may transmit the set of positioning signals 514 at the wireless device 506. The wireless device 502 may measure the set of positioning signals 512, and the wireless device 506 may measure the set of positioning signals 514. The wireless device 502 may receive measurements of sets of positioning signals from the network entity 508, the wireless device 506, and/or the wireless device 504. The wireless device 502 may calculate training associated information based on measuring the set of positioning signals 512. The wireless device 502 may use the positioning model to calculate a set of intermediate measurements that may be used to calculate the location of the wireless device 504 based on the set of training associated information and any received measurements of positioning signals. The calculated intermediate measurements may be transmitted to the network entity 508 (e.g., via a wireless transceiver or over the backhaul link) for the network entity 508 to calculate the position of the wireless device 504.

In another aspect, a system may be configured to train a positioning model at a network entity, for example the network entity 508, based on a set of uplink positioning signals, for example the set of positioning signals 512 received by the wireless device 502 and/or the set of positioning signals 514 received by the wireless device 506. For example, the network entity 508 may have a positioning model configured to calculate a position of the wireless device 504 based on a set of inputs. The label training data of the location of the wireless device 504 may be referred to as the set of estimated positioning labels (i.e., the estimated idealized outputs for the positioning model to calculate). The set of inputs may include a set of measurements taken at the wireless device 502 of the set of positioning signals 512 from the wireless device 504. The set of inputs may include a set of measurements taken at the wireless device 506 of the set of positioning signals 514 from the wireless device 504. The set of inputs may include a set of intermediate measurements calculated by the network entity 508 and/or received from a network node that receives uplink reference signals from the wireless device 504, such as the wireless device 502 that receives the set of positioning signals 512 from the wireless device 504 and/or the wireless device 506 that receives the set of positioning signals 514 from the wireless device 504.

The network entity 508 may train a positioning model based on a calculated location of the wireless device 504 and a set of inputs, such as measurements of the set of positioning signals 512 received at the wireless device 502, measurements of the set of positioning signals 514 received at the wireless device 506, intermediate measurements calculated at the wireless device 504, intermediate measurements calculated at the wireless device 502, intermediate measurements calculated at the wireless device 506, intermediate measurements calculated at the network entity 508, training associated information associated with the set of positioning signals 516 and/or the set of positioning signals 512 at the wireless device 502, training associated information associated with the set of positioning signals 518 and/or the set of positioning signals 514 at the wireless device 506, and/or labeling assistance information associated with the set of positioning signals 516, the set of positioning signals 512, the set of positioning signals 518, or the set of positioning signals 514 at the network entity 508. After the positioning model is trained, the network entity 508 may receive at least one of a set of measured positioning signals from the wireless device 502 and/or the wireless device 506, and/or training associated information associated with the measured positioning signals, and may calculate the location of the wireless device 504 based on the set of measured positioning signals and/or training assisted information associated with the measured positioning signals. The network entity 508 may configure the positioning performed using the wireless device 502, the wireless device 504, and the wireless device 506, for example scheduling the uplink positioning signals from the wireless device 504 to the wireless device 502 and/or the wireless device 506.

Such systems may enable network nodes, such as the wireless device 502 and/or the wireless device 506, to report training data measurements (i.e., sets of measured SRSs) and/or training data assistance information (i.e., training associated information) for training a positioning model at the network entity 508, at the wireless device 502, and/or at the wireless device 506. Such systems may enable network entities, such as the network entity 508, to report labeling assistance (i.e., labeling assistance information) for training a positioning model at the network entity 508, at the wireless device 502, and/or at the wireless device 506.

In some aspects, a network node may receive a set of SRSs from a wireless device. The network node may measure the set of SRSs. The network node may output at least one of a set of estimated positioning labels, training associated information, or labeling assistance information associated with the set of measured SRSs for a positioning model. The network node may output at least one of the set of estimated positioning labels, the training associated information, or the labeling assistance information by training the positioning model based on at least one of the set of estimated positioning labels, the training associated information, the labeling assistance information, or the set of measured SRSs. The network node may output at least one of the set of estimated positioning labels, the training associated information, or the labeling assistance information by transmitting, for a network entity, at least one of the set of estimated positioning labels, the training associated information, or the set of measured SRSs for training the positioning model.

In some aspects, a network entity may transmit a configuration for a set of SRSs from a wireless device to a network node. The network entity may receive at least one of a set of measured SRSs, a first set of estimated positioning labels, or training associated information associated with the set of SRSs. The network entity may output at least one of a second set of estimated positioning labels, labeling assistance information, the set of measured SRSs, or the training associated information associated with the set of SRSs for a positioning model. The network entity may output at least one of the second set of estimated positioning labels, the labeling assistance information, the set of measured SRSs, or the training associated information by training the positioning model based on at least one of the second set of estimated positioning labels, the labeling assistance information, the set of measured SRSs, or the training associated information. The network entity may output at least one of the second set of estimated positioning labels, the labeling assistance information, the set of measured SRSs, or the training associated information by transmitting, for the network node, at least one of the second set of estimated positioning labels or the labeling assistance information for training the positioning model.

In some aspects, a set of network nodes, such as the wireless device 502 and the wireless device 506, that receive positioning signals from a target wireless device, such as the wireless device 504, may be configured to report training data measurements and related assistance information for training a positioning model and to provide signaling for labels that are used to train a positioning model. Such a positioning model may be trained to operate on a network node that receives the positioning signals from the target wireless device, and/or may be trained to operate on a network entity that configures positioning, such as an LMF or a set of location servers.

In one aspect, the wireless device 502 and/or the wireless device 506 may be configured to collect data for training a network-side positioning model that calculates a position of the wireless device 504, or an intermediate measurement (e.g., a timing measurement, an angle measurement, and/or a LOS identification that may be used to calculate the position of the wireless device 504) based on measurements and/or associated information of positioning signals received from the wireless device 504, such as the set of positioning signals 512 and/or the set of positioning signals 514. The collected training data measurements may include UL-based basic measurements, such as RSTD, RSRP, RSRPP, AoA, and/or LOS identification measurements captured at a network node, such as the wireless device 502 and/or the wireless device 506. The collected training data measurements may include UL enhanced measurements, such as soft information (e.g., likelihood, probability, range, or distribution) of RSTD measurements, soft information of RSRP measurements, soft information of RSRPP measurements, soft information of AoD measurements, beam path information, LOS phase information, additional beam path phase information, and/or a joint composition of UL-based measurements. The collected training data measurements may include channel impulse response (CIR) measurements, channel frequency response (CFR) measurements, and/or power delay profile (PDP) measurements captured at the network nodes, such as the wireless device 502 and/or the wireless device 506. Such measurements may be shared by default to train a positioning model on a network device, such as a TRP or an LMF. In some aspects, the training data labels used to train the positioning model may include a known PRU location, a location of a UE obtained using a non-radio access technology (non-RAT) method (e.g., using an LIDAR sensor, a GNSS fix, a WLAN positioning method, other sensors at the wireless device), a location of a UE derived by an LMF, intermediate labels (labels used to calculate a location of the wireless device) based on reported measurements by the wireless device or a network node (e.g., a transmission reception point (TRP)), and/or intermediate labels obtained from an LMF (e.g., calculated by the LMF or received by the LMF from other wireless devices). In some aspects, the network entity 508 may provide assistance information to a network node (e.g., the wireless device 502 and/or the wireless device 506) for training a positioning model for use at the network node, or a network node may provide assistance information to the network entity 508 for training a positioning model for use at the network node. In some aspects, the positioning model may be trained by an offline entity or a separate network entity (e.g., an over-the-top (OTT) server) and then may be loaded by a network node or a network entity for calculating positioning information. In some aspects, the network entity 508 may provide other, associated, assistance information when providing labeling assistance to the wireless device 502 and/or the wireless device 506. In one aspect, the network entity 508 may provide an indication of reference signal resources that the network entity 508 used to calculate an intermediate label using RAT methods (e.g., a frame number a slot index, an ODFM symbol, a hyper frame number). In one aspect, the network entity 508 may provide enhanced timestamping of reference signal resources used to calculate an intermediate label using RAT methods (e.g., UTC timing). Similarly, in some aspects, the wireless device 502 and/or the wireless device 506 may provide other, associated, assistance information when providing labeling assistance to the network entity 508. In one aspect, the wireless device 502 and/or the wireless device 506 may provide an indication of reference signal resources that the network node used to derive the reported measurements (e.g., a frame number a slot index, an ODFM symbol, a hyper frame number). In one aspect, the wireless device 502 and/or the wireless device 506 may provide enhanced timestamping of reference signal resources used to calculate an intermediate label using RAT methods (e.g., UTC timing). In one aspect, the wireless device 502 and/or the wireless device 506 may provide TRP proprietary information, such as TRP-side beam information used to obtain measurements and/or to calculate intermediate labels for training the positioning model. Such proprietary information may be provided by default when providing information to train a positioning model for use at the network entity 508.

In some aspects, a network node, such as the wireless device 502 and/or the wireless device 506, may transmit a request to the network entity 508 to assist in collecting training data (e.g., labelling assistance) as part of an NRPPa framework. In some aspects, the network entity 508 may use an NR-UL-TDoA procedure, an NR-UL-AoA procedure, or an NR-multi-RTT procedure to both collect measurement information, and to calculate labels for training a positioning model. The network entity 508 may also be configured to provide assistance information to the requesting network node in addition to the labelling assistance. In some aspects, the network entity 508 may use a procedure dedicated for collecting training data. Such a procedure may be defined as part of an NRPPa framework. The network entity 508 may be configured to assist in coordinating between the set of network nodes collecting measurement training data (e.g., the wireless device 502 and/or the wireless device 506) and the target wireless device (e.g., the wireless device 504) and the network entity 508 may also provide some labeling assistance for training the positioning model for use with at least one of the set of network nodes.

In some aspects, the network entity 508 may transmit a request to at least some of the set of network nodes collecting the training data, such as the wireless device 502 and/or the wireless device 506, as part of an NRPPa framework. In some aspects, the wireless device 502 and/or the wireless device 506 may use an NR-UL-TDoA procedure, an NR-UL-AoA procedure, or an NR-multi-RTT procedure to both collect measurement information, and to calculate labels for training a positioning model. At least one of the set of network nodes may also be configured to provide assistance information to the requesting network node in addition to the labelling assistance. In some aspects, the wireless device 502 and/or the wireless device 506 may use a procedure dedicated for collecting training data. Such a procedure may be defined as part of an NRPPa framework.

Data collection exchange between the network entity 508 and the wireless device 502 and/or the wireless device 506 may be a part of NRPPa signaling. If a network node initiates the training data collection, the training data may be transmitted from the network entity 508 to the initiating network node. If the network entity 508 initiates the training data collection, at least one of the set of network nodes may transmit training data to the network entity 508. The training data collection session may be a part of the session capability exchange between a gNB and an LMF. The training data collection session may be a part of the session configuration exchange between a gNB and an LMF. The training data collection session may be a part of the session initiation from either a network node or the LMF. The training data collection session may be a part of a session error message. The training data collection session may be a part of a session pause message. The training data collection session may be a part of a session termination message.

In one example, at least one of the set of network nodes collecting training data, for example the wireless device 502, may transmit a request to the network entity 508 to provide its capability to be involved in a training data collection session (e.g., provide labelling assistance and/or other UE-side related assistance information, such as UE beam configurations). The request message may also include an indication of a type of labeling assistance requested (e.g., types of assistance information useful to train the positioning model). In response the network entity 508 may transmit an indication of its capability to assist the wireless device 502 in collecting training data and provide labeling information (e.g., an estimated location of the wireless device 504, intermediate measurements derived using known locations of network nodes that receive sets of positioning signals from the wireless device 504, other assistance information such as UE beam configurations). In response, the wireless device 502 may transmit to the network entity 508 with one or more requested configurations, such as an UL reference signal configuration, a periodicity in label assistance reporting, types of assistance information to provide (e.g., enhanced timing or enhanced resource indication). The network entity 508 may provide labels to the wireless device 502 for training the positioning model in accordance with any received configurations. The network entity 508 may provide additional meta data (e.g., assistance signaling), for example UE beam information, enhanced timing information, and/or an indication of resources used to calculate labels. In some aspects, the wireless device 502 may provide measurements to the network entity 508 along with some assistance information (e.g., enhanced timing), the network entity 508 may derive intermediate labels based on the measurements, and may provide the intermediate labels to the wireless device 502 for training the positioning model.

In another example, the network entity 508 may transmit a request to at least one of the set of network nodes, such as the wireless device 502, to provide its capability to be involved in a training data collection session (i.e., to provide labels and/or assistance information associated with the labels). The request message may include an indication of types of measurement that the wireless device 502 may support (e.g., CIR, CFR, PDP. ToA, RSTD, RSRP, RSRPP, and/or AoD associated with positioning signals transmitted by the wireless device 504). In response, the wireless device 502 may indicate its capability to collect training data based on an UL reference signal received by the wireless device 502 (e.g., an SRS). A plurality of the set of network nodes may respond to the network entity 508. The network entity 508 may select all, or a subset of, the network nodes that indicate that they are configured to provide such training assistance information. The network entity 508 may select the network nodes based on the capability information of the network nodes, for example all network nodes that support CIR of received SRSs. The network entity 508 may provide the wireless device 502 with one or more configurations, such as an UL reference signal configuration, types of measurements to be reported by the wireless device 502, periodicity of measurements, periodicity of label assistance reporting, and/or types of assistance information to provide (e.g., enhanced timing or enhanced resource indication). The wireless device 502 may collect measurements of the received positioning signals, such as the set of positioning signals 512, and may report the requested training measurements and/or labels to the network entity 508 according to the one or more configurations. In some aspects, the wireless device 502 may include additional meta data (e.g., assistance signaling), for example TRP beam information, TRP location information, and/or TRP proprietary information.

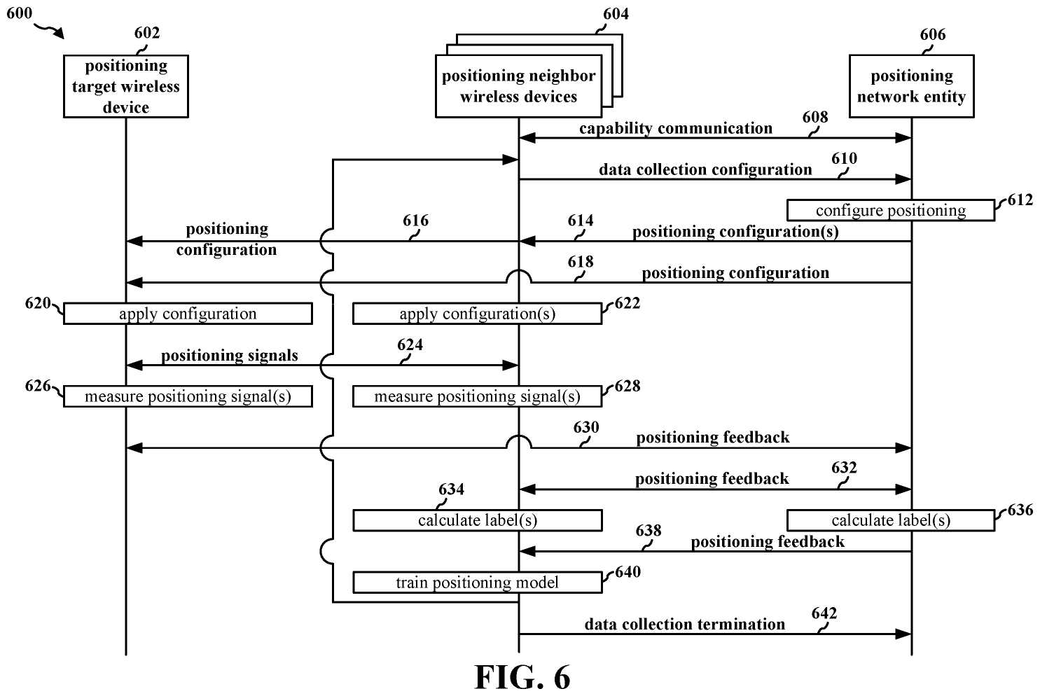

FIG. 6 is a connection flow diagram 600 illustrating an example of communications between a positioning target wireless device 602, a set of positioning neighbor wireless devices 604, and a positioning network entity 606 configured to train a positioning model at one or more of the set of positioning neighbor wireless devices 604. The positioning model may be configured to calculate a set of intermediate measurements that may be used to calculate the position of the positioning target wireless device 602. The positioning target wireless device 602 may be a UE or a PRU. The PRU may have a set of sensors that may be used to calculate the location of the PRU with a high degree of accuracy, such as a LIDAR sensor, a GNSS device, or a WLAN system configured to calculate a location of the positioning target wireless device 602 based on received WLAN signals. The PRU may be a fixed PRU with a known location, or may be a mobile PRU that is placed in a known location for the duration of collecting measurements for training the positioning model. The set of positioning neighbor wireless devices 604 may include a set of base stations and/or a set of TRPs configured to receive positioning signals transmitted from the positioning target wireless device 602. The positioning network entity 606 may include an LMF, or may include one or more location servers. The positioning network entity 606 may be configured to configure positioning between the positioning target wireless device 602 and the set of positioning neighbor wireless devices 604.

One or more of the set of positioning neighbor wireless devices 604 may transmit capability communication 608 to the positioning network entity 606. The positioning network entity 606 may receive capability communication 608 from one or more of the set of positioning neighbor wireless devices 604. The positioning network entity 606 may transmit capability communication 608 to one or more of the set of positioning neighbor wireless devices 604. One or more of the set of positioning neighbor wireless devices 604 may receive the capability communication 608 from the positioning network entity 606. The capability communication 608 may include capability of at least one of the set of positioning neighbor wireless devices 604 and/or the positioning network entity 606 to provide training data for a training a positioning model at one or more of the set of positioning neighbor wireless devices 604. For example, one or more of the set of positioning neighbor wireless devices 604 may transmit a request to the positioning network entity 606 to provide its capability to be involved in a training data collection session and provide labeling assistance and/or other network-side related assistance information (e.g., UE/PRU beam configurations, location information of the positioning target wireless device 702, location information of some of the set of positioning neighbor wireless devices 704, mapping for positioning signal resources to the positioning target wireless device 702, mapping for positioning signals resources to one or more of the beams for the positioning signals). The request message may also inquire the type of labeling assistance that the positioning network entity 606 may provide. The positioning network entity 606 may, in response, transmit its capability and/or any type of labeling assistance that it may provide to one or more of the set of positioning neighbor wireless devices 604. For example, the positioning network entity 606 may indicate its capability to assist one or more of the set of positioning neighbor wireless devices 604 in collecting training data and provide labeling assistance. In some aspects, the positioning network entity 606 may leverage a location label (e.g., a UE estimated location or a PRU known location) to calculate intermediate measurement labels based on its knowledge of locations of the positioning target wireless device 702 and/or the set of positioning neighbor wireless devices 604. This way, the positioning network entity 606 may provide the location of the positioning target wireless device 702 and/or a set of intermediate measurement labels to one or more of the set of positioning neighbor wireless devices 604 without providing proprietary information. In some aspects, the positioning network entity 606 may collect other assistance information, such as beam configurations of positioning signals transmitted by the positioning target wireless device 602.

One or more of the set of positioning neighbor wireless devices 604 may transmit a data collection configuration 610 to the positioning network entity 606. The positioning network entity 606 may receive the data collection configuration 610 from the subset of the set of positioning neighbor wireless devices 604. The data collection configuration 610 may include one or more attributes of a desired uplink reference signal configuration for the positioning target wireless device 602. In one aspect, the data collection configuration 610 may include a configuration for a set of SRSs transmitted from the positioning target wireless device 602 (e.g., to the set of positioning neighbor wireless devices 604). In one aspect, the data collection configuration 610 may include a requested periodicity for the positioning network entity 606 to provide label assistance reporting to the subset of the set of positioning neighbor wireless devices 604. In one aspect, the data collection configuration 610 may include whether the positioning network entity 606 should report any enhanced timing or resource indication used in labeling assistance. The data collection configuration 610 may include a new radio (NR) positioning protocol (NRPP) annex (NRPPa) message.

At 612, the positioning network entity 606 may configure positioning for the positioning target wireless device 602 and the set of positioning neighbor wireless devices 604. The positioning network entity 606 may transmit a set of positioning configurations 614 at the set of positioning neighbor wireless devices 604. The set of positioning neighbor wireless devices 604 may receive the set of positioning configurations 614. The positioning network entity 606 may transmit the positioning configuration 618 at the positioning target wireless device 602. The positioning target wireless device 602 may receive the positioning configuration 618 from the positioning network entity 606. In some aspects, a base station serving the positioning target wireless device 602 may transmit the positioning configuration 616 at the positioning target wireless device 602. The positioning configuration 616 may be based on one or more of the set of positioning configurations 614 received by the set of positioning neighbor wireless devices 604. The positioning target wireless device 602 may receive the positioning configuration 616 from the serving base station. A positioning configuration may include an indication to measure a time-difference of arrival (TDoA) associated with the set of positioning signals 624. A positioning configuration may include an indication to measure an angle of arrival (AoA) associated with the set of positioning signals 624. A positioning configuration may include an indication to measure multi-cell round trip time (multi-RTT) associated with the set of positioning signals 624.

At 620, the positioning target wireless device 602 may apply the received positioning configuration. At 622, the set of positioning neighbor wireless devices 604 may apply the set of received positioning configurations. The positioning configurations may configure the set of positioning signals 624. The set of positioning signals 624 may include one or more sets of SRSs transmitted by the positioning target wireless device 602 and received at the set of positioning neighbor wireless devices 604. At 628, the set of positioning neighbor wireless devices 604 may measure the set of positioning signals 624. The set of positioning signals 624 may include one or more sets of PRSs transmitted from the set of positioning neighbor wireless devices 604 and received at the positioning target wireless device 602. At 626, the positioning target wireless device 602 may measure the set of positioning signals 624.

The positioning target wireless device 602 may take any suitable measurement of the set of positioning signals 624. The set of positioning neighbor wireless devices 604 may take any suitable measurement of the set of positioning signals 624. For example, a wireless device may measure an RTOA measurement between a first signal of the set of positioning signals 624 received at a first wireless device of the set of positioning neighbor wireless devices 604 and a second signal of the set of positioning signals 624 received at a second wireless device of the set of positioning neighbor wireless devices 604. A wireless device may measure a probability of the RTOA (e.g., likelihood that the measured RTOA is accurate within a threshold error level). A wireless device may measure a range of the measured RTOA (e.g., a min/max of the measured RTOA within a threshold error level). A wireless device may measure an RSRP measurement of at least one of the set of positioning signals 624. The RSRP may be a measurement for all path contributions. A wireless device may measure a probability of the RSRP. A wireless device may measure a range of the measured RSRP. A wireless device may measure an RSRPP measurement of at least one of the set of positioning signals 624. The RSRPP may indicate the power contribution on a per path level. A wireless device may measure a probability of the RSRPP. A wireless device may measure a range of the measured RSRPP. A wireless device may measure an AoA measurement of at least one of the set of positioning signals 624. A wireless device may measure a probability of the AoA. A wireless device may measure a range of the measured AoA. A wireless device may measure an CIR measurement of at least one of the set of positioning signals 624. A wireless device may measure an CFR measurement of at least one of the set of positioning signals 624. A wireless device may measure an PDP measurement of at least one of the set of positioning signals 624.

The positioning target wireless device 602 may transmit positioning feedback 630 at the positioning network entity 606. The positioning network entity 606 may receive the positioning feedback 630 from the positioning target wireless device 602 may. The positioning feedback 630 may include measurements taken at 626. The positioning feedback 630 may include training associated information associated with the set of positioning signals 624 received by the positioning target wireless device 602. The positioning feedback 630 may include training associated information associated with the set of positioning signals 624 transmitted by the positioning target wireless device 602. The training associated information may include a frame number associated with the set of positioning signals 624. The training associated information may include a slot index associated with the set of positioning signals 624. The training associated information may include an OFDM symbol associated with the set of positioning signals 624. The training associated information may include a hyper frame number associated with the set of positioning signals 624. The training associated information may include an indication of UTC timing associated with the set of positioning signals 624. The training associated information may include an indication of a location of a network node associated with the set of positioning signals 624. The training associated information may include an indication of a location of a TRP associated with the set of positioning signals 624 and/or associated with a network node that receives the set of positioning signals 624. The training associated information may include an indication of an implementation error associated with the set of positioning signals 624. An implementation error may include, for example, synchronization errors at the positioning target wireless device 602, synchronization errors at one of the set of positioning neighbor wireless devices 604, timing errors at one of the set of positioning neighbor wireless devices 604, or timing errors at the positioning target wireless device 602. The training associated information may include a resource mapping associated with the set of positioning signals 624. The resource mapping may be between a resource (e.g., an SRS resource, a PRS resource), a location of one of the set of positioning neighbor wireless devices 604, a beam angle, and/or one of the set of positioning signals 624. The training associated information may include an indication of a label quality associated with an estimated label based on the set of positioning signals 624. The training associated information may include an indication of a quality associated with a measurement the set of positioning signals 624 (e.g., how reliable an RSRP or an RTOA measurement is). The training associated information may include a beam angle (e.g., AoA or AoD) associated with the set of positioning signals 624.

The set of positioning neighbor wireless devices 604 may transmit the positioning feedback 632 at the positioning network entity 606. The positioning network entity 606 may receive the positioning feedback 632 from the set of positioning neighbor wireless devices 604. The positioning network entity 606 may transmit the positioning feedback 632 at the set of positioning neighbor wireless devices 604. The set of positioning neighbor wireless devices 604 may receive the positioning feedback 632 from the positioning network entity 606. The positioning feedback 632 may include measurements and/or training associated information associated with measuring the set of positioning signals 624 received from the positioning target wireless device 602. The positioning feedback 632 may include training associated information. The positioning feedback 632 may include measurements taken at 628. The positioning feedback 632 may include training associated information associated with transmitting the set of positioning signals 624 from the positioning target wireless device 602 to the set of positioning neighbor wireless devices 604.

At 634, one or more of the set of positioning neighbor wireless devices 604 may calculate one or more labels, such as a position of the positioning target wireless device 602, or an intermediate label using one or more of the measurements taken at 628 and/or data received as the positioning feedback 632. In some aspects, at 636 the positioning network entity 606 may calculate one or more labels, such as a position of the positioning target wireless device 602, or an intermediate label using one or more of the measurements taken at 626, one or more of the measurements taken at 628 and/or data received as the positioning feedback 632 and/or positioning feedback 630. The positioning network entity 606 may transmit one or more of the calculated labels as the positioning feedback 638 to one or more of the positioning neighbor wireless devices 604.

At 640, one or more of the positioning neighbor wireless devices 604 may train the positioning model. In some aspects, one or more of the positioning neighbor wireless devices 604 may determine that the data collection configuration should be updated, for example if the input data or a label is too noisy. One or more of the positioning neighbor wireless devices 604 may then transmit an update as the data collection configuration 610 to the positioning network entity 606, continuing to massage the process of data collection training until the positioning model is well-trained.

When a subset of the set of positioning neighbor wireless devices 604 is finished training the positioning model, one or more of the set of positioning neighbor wireless devices 604 may transmit a data collection termination 642 to the positioning network entity 606. The positioning network entity 606 may receive the data collection termination 642 from one or more of the set of positioning neighbor wireless devices 604. The positioning network entity 606 may then terminate the positioning. The data collection termination 642 may include an NRPPa message.

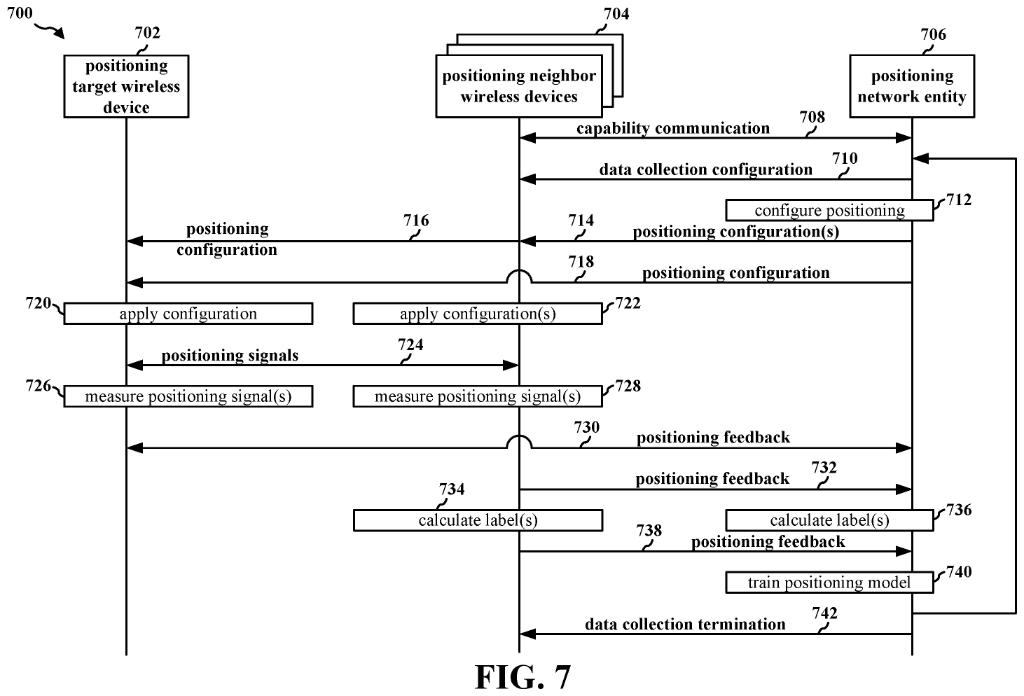

FIG. 7 is a connection flow diagram 700 illustrating an example of communications between a positioning target wireless device 702, a set of positioning neighbor wireless devices 704, and a positioning network entity 706 configured to train a positioning model at the positioning network entity 706. The positioning model may be configured to calculate a position and/or a location of the positioning target wireless device 702. The positioning target wireless device 702 may be a UE or a PRU. The PRU may have a set of sensors that may be used to calculate the location of the PRU with a high degree of accuracy, such as a LIDAR sensor, a GNSS device, or a WLAN system configured to calculate a location of the positioning target wireless device 702 based on received WLAN signals. The PRU may be a fixed PRU with a known location, or may be a mobile PRU that is placed in a known location for the duration of collecting measurements for training the positioning model. The set of positioning neighbor wireless devices 704 may include a set of base stations and/or a set of TRPs configured to receive positioning signals transmitted from the positioning target wireless device 702. The positioning network entity 706 may include an LMF, or may include one or more location servers. The positioning network entity 706 may be configured to configure positioning between the positioning target wireless device 702 and the set of positioning neighbor wireless devices 704.

One or more of the set of positioning neighbor wireless devices 704 may transmit capability communication 708 to the positioning network entity 706. The positioning network entity 706 may receive capability communication 708 from one or more of the set of positioning neighbor wireless devices 704. The positioning network entity 706 may transmit capability communication 708 to one or more of the set of positioning neighbor wireless devices 704. One or more of the set of positioning neighbor wireless devices 704 may receive the capability communication 708 from the positioning network entity 706. The capability communication 708 may include capability of at least one of the set of positioning neighbor wireless devices 704 and/or the positioning network entity 706 to provide training data for a training a positioning model at one or more of the set of positioning neighbor wireless devices 704. For example, one or more of the set of positioning neighbor wireless devices 704 may transmit a request to the positioning network entity 706 to provide its capability to be involved in a training data collection session and provide labeling assistance and/or other network-side related assistance information (e.g., UE/PRU beam configurations, location information of the positioning target wireless device 702, location information of some of the set of positioning neighbor wireless devices 704, mapping for positioning signal resources to the positioning target wireless device 702, mapping for positioning signals resources to one or more of the beams for the positioning signals). The request message may also inquire the type of labeling assistance that the positioning network entity 706 may provide. The positioning network entity 706 may, in response, transmit its capability and/or any type of labeling assistance that it may provide to one or more of the set of positioning neighbor wireless devices 704. For example, the positioning network entity 706 may indicate its capability to assist one or more of the set of positioning neighbor wireless devices 704 in collecting training data and provide labeling assistance. In some aspects, the positioning network entity 706 may leverage a location label (e.g., a UE estimated location or a PRU known location) to calculate intermediate measurement labels based on its knowledge of locations of the positioning target wireless device 702 and/or the set of positioning neighbor wireless devices 704. This way, the positioning network entity 706 may provide the location of the positioning target wireless device 702 and/or a set of intermediate measurement labels to one or more of the set of positioning neighbor wireless devices 704 without providing proprietary information. In some aspects, the positioning network entity 706 may collect other assistance information, such as beam configurations of positioning signals transmitted by the positioning target wireless device 702.

The positioning network entity 706 may transmit a data collection configuration 710 to a subset of the set of positioning neighbor wireless devices 704 that have capability to support training the positioning model at the positioning network entity 706. The positioning network entity 706 may receive the data collection configuration 710 from the subset of the set of positioning neighbor wireless devices 704. The data collection configuration 710 may include one or more attributes of a desired uplink reference signal configuration for the positioning target wireless device 702. In one aspect, the data collection configuration 710 may include a configuration for a set of SRSs transmitted from the positioning target wireless device 702 (e.g., to the set of positioning neighbor wireless devices 704). In one aspect, the data collection configuration 710 may include a requested periodicity for the positioning network entity 706 to provide label assistance reporting to the subset of the set of positioning neighbor wireless devices 704. In one aspect, the data collection configuration 710 may include whether the positioning network entity 706 should report any enhanced timing or resource indication used in labeling assistance. The data collection configuration 710 may include an NRPPa message.

At 712, the positioning network entity 706 may configure positioning for the positioning target wireless device 702 and the set of positioning neighbor wireless devices 704. The positioning network entity 706 may transmit a set of positioning configurations 714 at the set of positioning neighbor wireless devices 704. The set of positioning neighbor wireless devices 704 may receive the set of positioning configurations 714. The positioning network entity 706 may transmit the positioning configuration 718 at the positioning target wireless device 702. The positioning target wireless device 702 may receive the positioning configuration 718 from the positioning network entity 706. In some aspects, a base station serving the positioning target wireless device 702 may transmit the positioning configuration 716 at the positioning target wireless device 702. The positioning configuration 716 may be based on one or more of the set of positioning configurations 714 received by the set of positioning neighbor wireless devices 704. The positioning target wireless device 702 may receive the positioning configuration 716 from the serving base station. A positioning configuration may include an indication to measure a TDoA associated with the set of positioning signals 724. A positioning configuration may include an indication to measure an AoA associated with the set of positioning signals 724. A positioning configuration may include an indication to measure multi-RTT associated with the set of positioning signals 724.

At 720, the positioning target wireless device 702 may apply the received positioning configuration. At 722, the set of positioning neighbor wireless devices 704 may apply the set of received positioning configurations. The positioning configurations may configure the set of positioning signals 724. The set of positioning signals 724 may include one or more sets of SRSs transmitted by the positioning target wireless device 702 and received at the set of positioning neighbor wireless devices 704. At 728, the set of positioning neighbor wireless devices 704 may measure the set of positioning signals 724. The set of positioning signals 724 may include one or more sets of PRSs transmitted from the set of positioning neighbor wireless devices 704 and received at the positioning target wireless device 702. At 726, the positioning target wireless device 702 may measure the set of positioning signals 724.

The positioning target wireless device 702 may take any suitable measurement of the set of positioning signals 724. The set of positioning neighbor wireless devices 704 may take any suitable measurement of the set of positioning signals 724. For example, a wireless device may measure an RTOA measurement between a first signal of the set of positioning signals 724 received at a first wireless device of the set of positioning neighbor wireless devices 704 and a second signal of the set of positioning signals 724 received at a second wireless device of the set of positioning neighbor wireless devices 704. A wireless device may measure a probability of the RTOA (e.g., likelihood that the measured RTOA is accurate within a threshold error level). A wireless device may measure a range of the measured RTOA (e.g., a min/max of the measured RTOA within a threshold error level). A wireless device may measure an RSRP measurement of at least one of the set of positioning signals 724. The RSRP may be a measurement for all path contributions. A wireless device may measure a probability of the RSRP. A wireless device may measure a range of the measured RSRP. A wireless device may measure an RSRPP measurement of at least one of the set of positioning signals 724. The RSRPP may indicate the power contribution on a per path level. A wireless device may measure a probability of the RSRPP. A wireless device may measure a range of the measured RSRPP. A wireless device may measure an AoA measurement of at least one of the set of positioning signals 724. A wireless device may measure a probability of the AoA. A wireless device may measure a range of the measured AoA. A wireless device may measure an CIR measurement of at least one of the set of positioning signals 724. A wireless device may measure an CFR measurement of at least one of the set of positioning signals 724. A wireless device may measure an PDP measurement of at least one of the set of positioning signals 724.

The positioning target wireless device 702 may transmit positioning feedback 730 at the positioning network entity 706. The positioning network entity 706 may receive the positioning feedback 730 from the positioning target wireless device 702 may. The positioning feedback 730 may include measurements taken at 726. The positioning feedback 730 may include training associated information associated with the set of positioning signals 724 received by the positioning target wireless device 702. The positioning feedback 730 may include training associated information associated with the set of positioning signals 724 transmitted by the positioning target wireless device 702. The training associated information may include a frame number associated with the set of positioning signals 724. The training associated information may include a slot index associated with the set of positioning signals 724. The training associated information may include an OFDM symbol associated with the set of positioning signals 724. The training associated information may include a hyper frame number associated with the set of positioning signals 724. The training associated information may include an indication of UTC timing associated with the set of positioning signals 724. The training associated information may include an indication of a location of a network node associated with the set of positioning signals 724. The training associated information may include an indication of a location of a TRP associated with the set of positioning signals 724 and/or associated with a network node that receives the set of positioning signals 724. The training associated information may include an indication of an implementation error associated with the set of positioning signals 724. An implementation error may include, for example, synchronization errors at the positioning target wireless device 702, synchronization errors at one of the set of positioning neighbor wireless devices 704, timing errors at one of the set of positioning neighbor wireless devices 704, or timing errors at the positioning target wireless device 702. The training associated information may include a resource mapping associated with the set of positioning signals 724. The resource mapping may be between a resource (e.g., an SRS resource, a PRS resource), a location of one of the set of positioning neighbor wireless devices 704, a beam angle, and/or one of the set of positioning signals 724. The training associated information may include an indication of a label quality associated with an estimated label based on the set of positioning signals 724. The training associated information may include an indication of a quality associated with a measurement the set of positioning signals 724 (e.g., how reliable an RSRP or an RTOA measurement is). The training associated information may include a beam angle (e.g., AoA or AoD) associated with the set of positioning signals 724.

The set of positioning neighbor wireless devices 704 may transmit the positioning feedback 732 at the positioning network entity 706. The positioning network entity 706 may receive the positioning feedback 732 from the set of positioning neighbor wireless devices 704. The positioning network entity 706 may transmit the positioning feedback 732 at the set of positioning neighbor wireless devices 704. The set of positioning neighbor wireless devices 704 may receive the positioning feedback 732 from the positioning network entity 706. The positioning feedback 732 may include measurements and/or training associated information associated with measuring the set of positioning signals 724 received from the positioning target wireless device 702. The positioning feedback 732 may include training associated information. The positioning feedback 732 may include measurements taken at 728. The positioning feedback 732 may include training associated information associated with transmitting the set of positioning signals 724 from the positioning target wireless device 702 to the set of positioning neighbor wireless devices 704.

At 734, one or more of the set of positioning neighbor wireless devices 704 may calculate one or more labels, such as a position of the positioning target wireless device 702, or an intermediate label using one or more of the measurements taken at 728 and/or data received as the positioning feedback 732. In some aspects, at 736 the positioning network entity 706 may calculate one or more labels, such as a position of the positioning target wireless device 702, or an intermediate label using one or more of the measurements taken at 726, one or more of the measurements taken at 728 and/or data received as the positioning feedback 732 and/or positioning feedback 730. One or more of the set of positioning neighbor wireless devices 704 may transmit one or more of the calculated labels as the positioning feedback 738 to the positioning network entity 706.

At 740, the positioning network entity 706 may train the positioning model. In some aspects, the positioning network entity 706 may determine that the data collection configuration should be updated, for example if the input data or a label is too noisy. The positioning network entity 706 may then transmit an update as the data collection configuration 710 to one or more of the set of positioning neighbor wireless devices 704, continuing to massage the process of data collection training until the positioning model is well-trained.

When the positioning network entity 706 is finished training the positioning model, the positioning network entity 706 may transmit a data collection termination 742 to one or more of the set of positioning neighbor wireless devices 704. One or more of the set of positioning neighbor wireless devices 704 may receive the data collection termination 742 from the positioning network entity 706. The subset of the set of positioning neighbor wireless devices 704 supporting the positioning network entity 706 in training the positioning model may then terminate the positioning. The data collection termination 742 may include an NRPPa message.

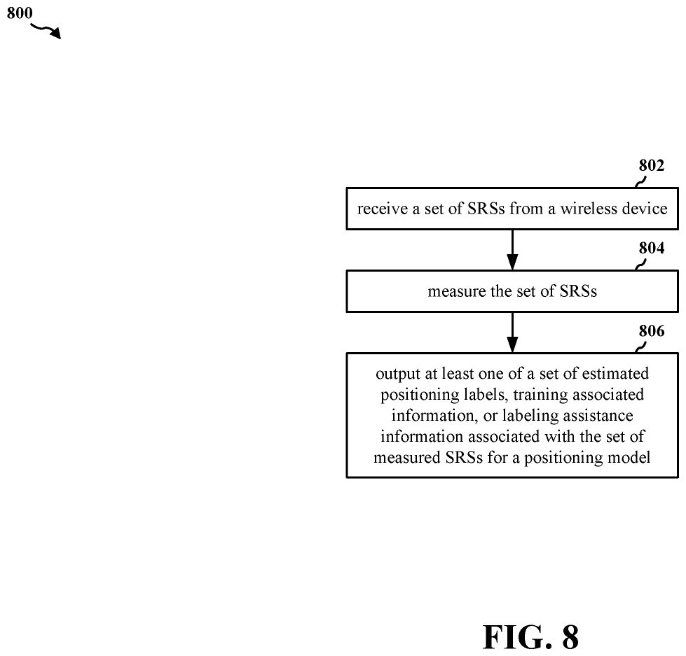

FIG. 8 is a flowchart 800 of a method of wireless communication. The method may be performed by a network node (e.g., the base station 102, the base station 310; the wireless device 402, the wireless device 406, the wireless device 502, the wireless device 506, the set of positioning neighbor wireless devices 604, the set of positioning neighbor wireless devices 704; the network entity 1002, the network entity 1160). At 802, the network node may receive a set of SRSs from a wireless device. For example, 802 may be performed by one of the set of positioning neighbor wireless devices 604 in FIG. 6, which may receive the set of positioning signals 624 from the positioning target wireless device 602. The set of positioning signals 624 may include a set of SRSs. Moreover, 802 may be performed by the component 198 in FIG. 1, 3, 10, or 11.

At 804, the network node may measure the set of SRSs. For example, 804 may be performed by one of the set of positioning neighbor wireless devices 604 in FIG. 6, which may, at 628, measure the set of positioning signals 624. Moreover, 804 may be performed by the component 198 in FIG. 1, 3, 10, or 11.

At 806, the network node may output at least one of a set of estimated positioning labels, training associated information, or labeling assistance information associated with the set of measured SRSs for a positioning model. For example, 806 may be performed by one of the set of positioning neighbor wireless devices 604 in FIG. 6, which may, at 640, train a positioning model based on estimated positioning labels calculated at 634 at one of the set of positioning neighbor wireless devices 604 and/or at estimated positioning labels calculated at 636 at the positioning network entity 606. One of the set of positioning neighbor wireless devices 604 may, at 640, train a positioning model based on training assistance information associated with measuring the set of positioning signals 624. One of the set of positioning neighbor wireless devices 604 may, at 640, train a positioning model based on labeling assistance information received as the positioning feedback 638 received from the positioning network entity 606. Moreover, 806 may be performed by the component 198 in FIG. 1,3, 10, or 11.

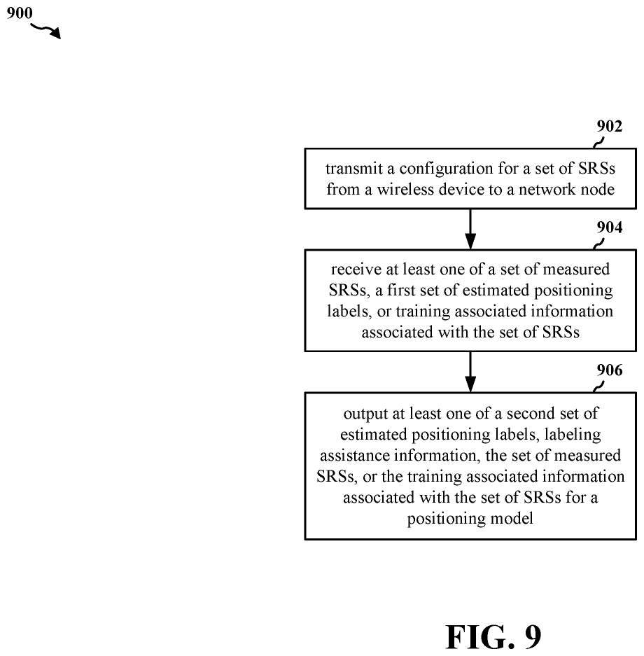

FIG. 9 is a flowchart 900 of a method of wireless communication. The method may be performed by a network entity (e.g., the base station 102, the base station 310; the wireless device 402, the wireless device 406; the network entity 508, the positioning network entity 606, the positioning network entity 706; the network entity 1002, the network entity 1160). At 902, the network entity may transmit a configuration for a set of SRSs from a wireless device to a network node. For example, 902 may be performed by the positioning network entity 706 in FIG. 7, which may transmit a data collection configuration 710 for the set of positioning signals 724. The set of positioning signals 724 may include a set of SRSs transmitted from the positioning target wireless device 702 to the set of positioning neighbor wireless devices 704. Moreover, 902 may be performed by the component 199 in FIG. 1, 3, 10, or 11.

At 904, the network entity may receive at least one of a set of measured SRSs, a first set of estimated positioning labels, or training associated information associated with the set of SRSs. For example, 904 may be performed by the positioning network entity 706 in FIG. 7, which may receive a set of measured SRSs as the positioning feedback 732 and/or the positioning feedback 738. The positioning network entity 706 may receive a set of estimated positioning labels calculated at 734 at the set of positioning neighbor wireless devices 704 as the positioning feedback 732 and/or the positioning feedback 738. The positioning network entity 706 may receive training associated information associated with the set of positioning signals 724 as the positioning feedback 732 and/or the positioning feedback 738. Moreover, 904 may be performed by the component 199 in FIG. 1, 3, 10, or 11.

At 906, the network entity may output at least one of a second set of estimated positioning labels, labeling assistance information, the set of measured SRSs, or the training associated information associated with the set of SRSs for a positioning model. For example, 906 may be performed by the positioning network entity 706 in FIG. 7, which may, at 740, train a positioning model based on the estimated positioning labels calculated at 734 and/or the estimated positioning labels calculated at 736. The positioning network entity 706 may, at 740, train a positioning model based on the labeling assistance information associated the estimated positioning labels. The positioning network entity 706 may, at 740, train a positioning model based on the set of measured SRSs received as the positioning feedback 732 and/or the positioning feedback 738. The positioning network entity 706 may, at 740, train a positioning model based on the training associated information associated with the set of positioning signals 724 received as the positioning feedback 732 and/or the positioning feedback 738.

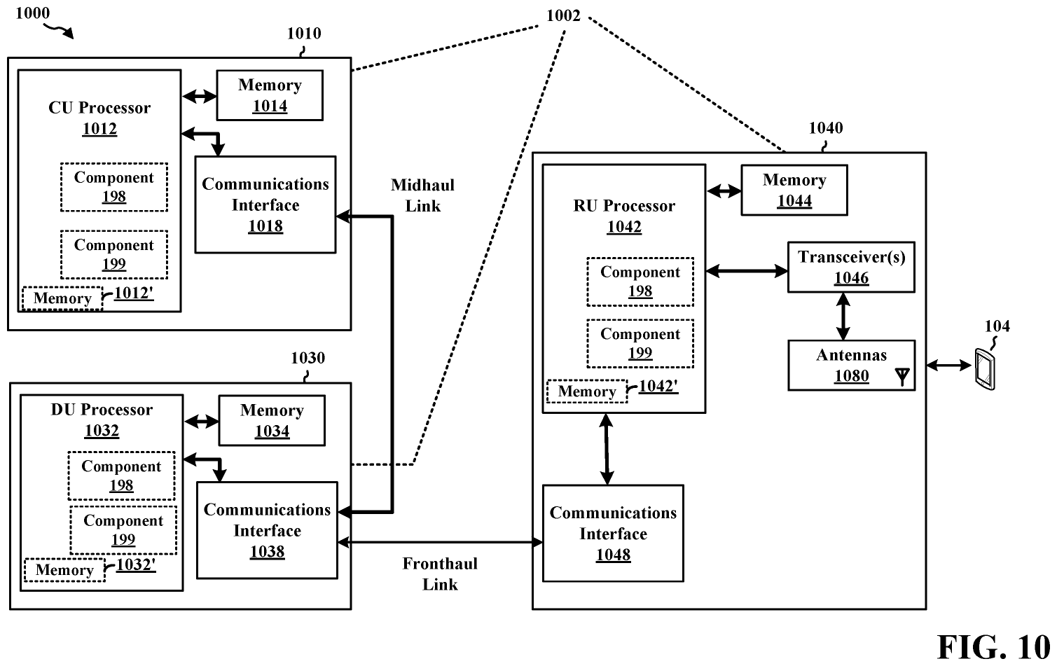

FIG. 10 is a diagram 1000 illustrating an example of a hardware implementation for a network entity 1002. The network entity 1002 may be a BS, a component of a BS, or may implement BS functionality. The network entity 1002 may include at least one of a CU 1010, a DU 1030, or an RU 1040. For example, depending on the layer functionality handled by the component 199, the network entity 1002 may include the CU 1010; both the CU 1010 and the DU 1030; each of the CU 1010, the DU 1030, and the RU 1040; the DU 1030; both the DU 1030 and the RU 1040; or the RU 1040. The CU 1010 may include a CU processor 1012. The CU processor 1012 may include on-chip memory 1012′. In some aspects, the CU 1010 may further include additional memory modules 1014 and a communications interface 1018. The CU 1010 communicates with the DU 1030 through a midhaul link, such as an F1 interface. The DU 1030 may include a DU processor 1032. The DU processor 1032 may include on-chip memory 1032′. In some aspects, the DU 1030 may further include additional memory modules 1034 and a communications interface 1038. The DU 1030 communicates with the RU 1040 through a fronthaul link. The RU 1040 may include an RU processor 1042. The RU processor 1042 may include on-chip memory 1042′. In some aspects, the RU 1040 may further include additional memory modules 1044, one or more transceivers 1046, antennas 1080, and a communications interface 1048. The RU 1040 communicates with the UE 104. The on-chip memory 1012′, 1032′. 1042′ and the additional memory modules 1014, 1034, 1044 may each be considered a computer-readable medium/memory. Each computer-readable medium/memory may be non-transitory. Each of the processors 1012, 1032, 1042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to receive a set of SRSs from a wireless device, such as the UE 104. The component 198 may be configured to measure the set of SRSs. The component 198 may be configured to output at least one of a set of estimated positioning labels, training associated information, or labeling assistance information associated with the set of measured SRSs for a positioning model. The component 198 may be within one or more processors of one or more of the CU 1010, DU 1030, and the RU 1040. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1002 may include a variety of components configured for various functions. In one configuration, the network entity 1002 may include means for receiving a set of SRSs from a wireless device. The network entity 1002 may include means for measuring the set of SRSs. The network entity 1002 may include means for outputting at least one of a set of estimated positioning labels, training associated information, or labeling assistance information associated with the set of measured SRSs for a positioning model. The network entity 1002 may include means for outputting at least one of the set of estimated positioning labels, the training associated information, or the labeling assistance information by locally training the positioning model based on at least one of the set of estimated positioning labels, the training associated information, the labeling assistance information, or the set of measured SRSs on a memory of the network entity 1002. The network entity 1002 may include means for outputting at least one of the set of estimated positioning labels, the training associated information, or the labeling assistance information by transmitting, for another network entity (e.g., an LMF, a training entity), at least one of the set of estimated positioning labels, the training associated information, or the set of measured SRSs for training the positioning model. The network entity 1002 may include means for receiving, from the “another” network entity, a request for at least one of the set of estimated positioning labels, the training associated information, or the set of measured SRSs. The network entity 1002 may include means for transmitting at least one of the set of estimated positioning labels, the training associated information, or the set of measured SRSs in response to the request. The request may include an NRPPa message. The network entity 1002 may include means for receiving a configuration for the set of SRSs associated with the request. The configuration may include an indication to measure at least one of (a) a TDoA associated with the set of SRSs. (b) an AoA associated with the set of SRSs, or (c) a multi-RTT associated with the set of SRSs. The network entity 1002 may include means for estimating the set of estimated positioning labels based on at least one of the training associated information, the labeling assistance information, or the set of measured SRSs. The set of measured SRSs may include at least one of (a) an RTOA, (b) an RSRP, (c) an RSRPP. (d) an AoA, (c) an LOS identification, (f) a first probability of the RTOA, (g) a second probability of the RSRP. (h) a third probability of the RSRPP. (i) a fourth probability of the AoA. (j) a first range of the RTOA, (k) a second range of the RSRP, (l) a third range of the RSRPP. (m) a fourth range of the AoA, (n) a CIR, (o) a CFR, or (p) a PDP. The set of estimated positioning labels may include at least one of (a) an RTOA. (b) an RSRP, (c) an RSRPP. (d) an AoA, (c) an LOS identification, (f) a first probability of the RTOA, (g) a second probability of the RSRP. (h) a third probability of the RSRPP, (i) a fourth probability of the AoA. (j) a first range of the RTOA. (k) a second range of the RSRP. (l) a third range of the RSRPP, (m) a fourth range of the AoA, (n) a CIR. (o) a CFR. (p) a PDP, (q) an indication of a location of the wireless device, or (r) a ToA. The network entity 1002 may include means for receiving, from another network entity (e.g., a core network component, an LMF), at least one of the set of estimated positioning labels or the labeling assistance information. The network entity 1002 may include means for transmitting, for the “another” network entity, a request for at least one of the set of estimated positioning labels or the labeling assistance information. The network entity 1002 may include means for receiving at least one of the set of estimated positioning labels or the labeling assistance information in response to the request. The request may include an NRPPa message. The network entity 1002 may include means for receiving a configuration for the set of SRSs in response to the request. The configuration may include an indication to measure at least one of (a) a TDoA associated with the set of SRSs. (b) an AoA associated with the set of SRSs, or (c) a multi-RTT associated with the set of SRSs. The labeling assistance information may include at least one of (a) a frame number associated with a subset of the set of estimated positioning labels, (b) a slot index associated with the subset of the set of estimated positioning labels, (c) an OFDM symbol associated with the subset of the set of estimated positioning labels, (d) a hyper frame number associated with the subset of the set of estimated positioning labels, or (e) an indication of a UTC timing associated with the subset of the set of estimated positioning labels. The training associated information may include at least one of (a) a frame number associated with the set of measured SRSs, (b) a slot index associated with the set of measured SRSs, (c) an OFDM symbol associated with the set of measured SRSs, (d) a hyper frame number associated with the set of measured SRSs. (c) a first indication of a UTC timing associated with the set of measured SRSs, (f) a second indication of a first location of the network node, (g) a third indication of a second location of a TRP associated with the network node, (h) a fourth indication of an implementation error, (i) a resource mapping associated with the set of SRSs. (j) a fifth indication of a label quality, (k) a sixth indication of a quality associated with at least one of the set of measured SRSs, or (l) a beam angle associated with the set of measured SRSs. The wireless device may include a UE or a PRU. The network entity 1002 may include means for 888. The means may be the component 198 of the network entity 1002 configured to perform the functions recited by the means. As described supra, the network entity 1002 may include the TX processor 316, the RX processor 370, and the controller/processor 375. As such, in one configuration, the means may be the TX processor 316, the RX processor 370, and/or the controller/processor 375 configured to perform the functions recited by the means.

As discussed supra, the component 199 may be configured to transmit a configuration for a set of SRSs from a wireless device, such as the UE 104, to a network node, such as another network entity 1002. The component 199 may be configured to receive at least one of a set of measured SRSs, a first set of estimated positioning labels, or training associated information associated with the set of SRSs. The component 199 may be configured to output at least one of a second set of estimated positioning labels, labeling assistance information, the set of measured SRSs, or the training associated information associated with the set of SRSs for a positioning model. The component 199 may be within one or more processors of one or more of the CU 1010, DU 1030, and the RU 1040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1002 may include a variety of components configured for various functions. In one configuration, the network entity 1002 may include means for transmitting a configuration for a set of SRSs from a wireless device to a network node. The network entity 1002 may include means for receiving at least one of a set of measured SRSs, a first set of estimated positioning labels, or training associated information associated with the set of SRSs. The network entity 1002 may include means for outputting at least one of a second set of estimated positioning labels, labeling assistance information, the set of measured SRSs, or the training associated information associated with the set of SRSs for a positioning model. The network entity 1002 may include means for outputting at least one of the second set of estimated positioning labels, the labeling assistance information, the set of measured SRSs, or the training associated information by training the positioning model on a local memory of the network entity 1002 based on at least one of the second set of estimated positioning labels, the labeling assistance information, the set of measured SRSs, or the training associated information. The network entity 1002 may include means for outputting at least one of the second set of estimated positioning labels, the labeling assistance information, the set of measured SRSs, or the training associated information by transmitting, for the network node, at least one of the second set of estimated positioning labels or the labeling assistance information for training the positioning model. The network entity 1002 may include means for receiving, from the network node, a request for at least one of the second set of estimated positioning labels or the labeling assistance information. The network entity 1002 may include means for transmitting at least one of the second set of estimated positioning labels or the labeling assistance information in response to the request. The request may include an NRPPa message. The network entity 1002 may include means for transmitting the configuration for the set of SRSs in response to the request. The network entity 1002 may include an LMF. The network entity 1002 may include means for transmitting a request for at least one of the set of measured SRSs, the first set of estimated positioning labels, or the training associated information. The network entity 1002 may include means for receiving at least one of the set of measured SRSs, the first set of estimated positioning labels, or the training associated information in response to the request. The request may include an NRPPa message. The network entity 1002 may include means for the configuration may include an indication to measure at least one of (a) a TDoA associated with the set of SRSs. (b) an AoA associated with the set of SRSs, or (c) a multi-RTT associated with the set of SRSs. The network entity 1002 may include means for estimating the second set of estimated positioning labels based on at least one of the set of measured SRSs, the first set of estimated positioning labels, or the training associated information. The set of measured SRSs may include at least one of (a) an RTOA. (b) an RSRP. (c) an RSRPP, (d) an AoA, (c) an LOS identification, (f) a first probability of the RTOA. (g) a second probability of the RSRP. (h) a third probability of the RSRPP. (i) a fourth probability of the AoA, (j) a first range of the RTOA, (k) a second range of the RSRP. (l) a third range of the RSRPP, (m) a fourth range of the AoA. (n) a CIR, (o) a CFR, or (p) a PDP. The first set of estimated positioning labels may include at least one of (a) an RTOA, (b) an RSRP, (c) an RSRPP. (d) an AoA. (c) an LOS identification. (f) a first probability of the RTOA, (g) a second probability of the RSRP, (h) a third probability of the RSRPP. (i) a fourth probability of the AoA. (j) a first range of the RTOA. (k) a second range of the RSRP. (l) a third range of the RSRPP, (m) a fourth range of the AoA, (n) a CIR, (o) a CFR. (p) a PDP. (q) an indication of a location of the wireless device, or (r) a ToA. The network entity 1002 may include means for receiving the first set of estimated positioning labels by receiving, from the wireless device, a first subset of the first set of estimated positioning labels. The network entity 1002 may include means for receiving the first set of estimated positioning labels by receiving, from the network node, a second subset of the first set of estimated positioning labels. The labeling assistance information may include at least one of (a) a frame number associated with a subset of the set of estimated positioning labels, (b) a slot index associated with the subset of the set of estimated positioning labels, (c) an OFDM symbol associated with the subset of the set of estimated positioning labels, (d) a hyper frame number associated with the subset of the set of estimated positioning labels, or (c) an indication of a UTC timing associated with the subset of the set of estimated positioning labels. The training associated information may include at least one of (a) a frame number associated with the set of measured SRSs, (b) a slot index associated with the set of measured SRSs, (c) an orthogonal frequency-division multiplexing (OFDM) symbol associated with the set of measured SRSs. (d) a hyper frame number associated with the set of measured SRSs, (c) a first indication of a coordinated universal time (UTC) timing associated with the set of measured SRSs, (f) a second indication of a first location of the network node, (g) a third indication of a second location of a transmission reception point (TRP) associated with the network node, (h) a fourth indication of an implementation error, (i) a resource mapping associated with the set of SRSs, (j) a fifth indication of a label quality, (k) a sixth indication of a quality associated with at least one of the set of measured SRSs, or (l) a beam angle associated with the set of measured SRSs. The wireless device may include a UE or a PRU. The means may be the component 199 of the network entity 1002 configured to perform the functions recited by the means. As described supra, the network entity 1002 may include the TX processor 316, the RX processor 370, and the controller/processor 375. As such, in one configuration, the means may be the TX processor 316, the RX processor 370, and/or the controller/processor 375 configured to perform the functions recited by the means.

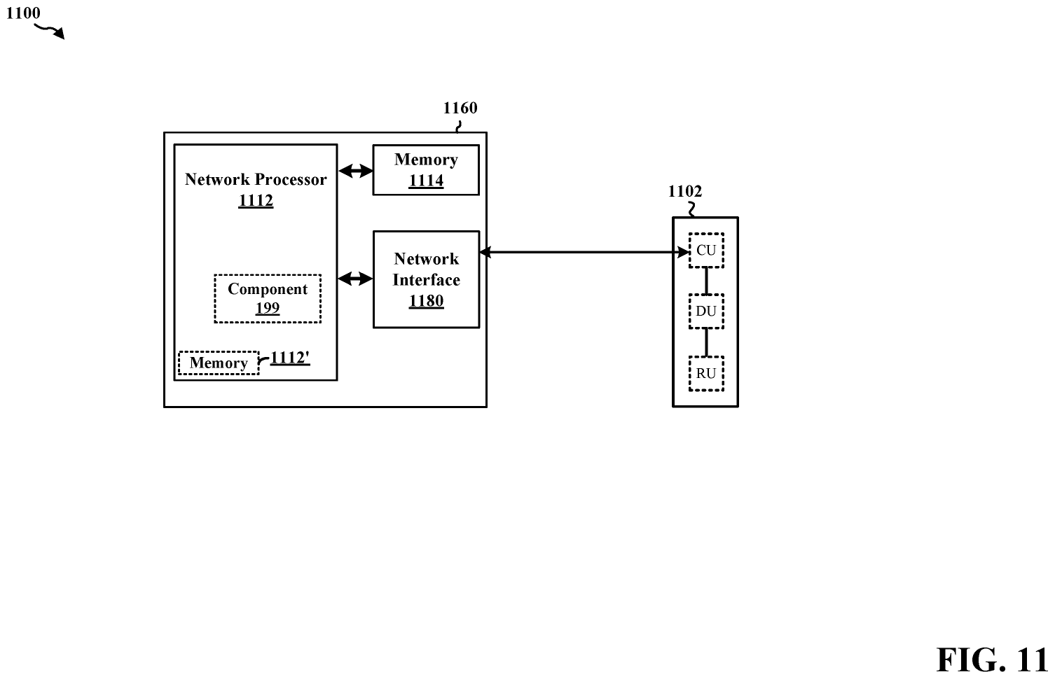

FIG. 11 is a diagram 1100 illustrating an example of a hardware implementation for a network entity 1160. In one example, the network entity 1160 may be within the core network 110. The network entity 1160 may include a network processor 1112. The network processor 1112 may include on-chip memory 1112′. In some aspects, the network entity 1160 may further include additional memory modules 1114. The network entity 1160 communicates via the network interface 1180 directly (e.g., backhaul link) or indirectly (e.g., through a RIC) with the CU 1102. The on-chip memory 1112′ and the additional memory modules 1114 may each be considered a computer-readable medium/memory. Each computer-readable medium/memory may be non-transitory. The processor 1112 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit a configuration for a set of SRSs from a wireless device, such as the UE 104, to a network node, such as another network entity 1002. The component 199 may be configured to receive at least one of a set of measured SRSs, a first set of estimated positioning labels, or training associated information associated with the set of SRSs. The component 199 may be configured to output at least one of a second set of estimated positioning labels, labeling assistance information, the set of measured SRSs, or the training associated information associated with the set of SRSs for a positioning model. The component 199 may be within the processor 1112. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1160 may include a variety of components configured for various functions. In one configuration, the network entity 1160 may include means for transmitting a configuration for a set of SRSs from a wireless device to a network node. The network entity 1160 may include means for receiving at least one of a set of measured SRSs, a first set of estimated positioning labels, or training associated information associated with the set of SRSs. The network entity 1160 may include means for outputting at least one of a second set of estimated positioning labels, labeling assistance information, the set of measured SRSs, or the training associated information associated with the set of SRSs for a positioning model. The network entity 1160 may include means for outputting at least one of the second set of estimated positioning labels, the labeling assistance information, the set of measured SRSs, or the training associated information by training the positioning model on a local memory of the network entity 1160 based on at least one of the second set of estimated positioning labels, the labeling assistance information, the set of measured SRSs, or the training associated information. The network entity 1160 may include means for outputting at least one of the second set of estimated positioning labels, the labeling assistance information, the set of measured SRSs, or the training associated information by transmitting, for the network node, at least one of the second set of estimated positioning labels or the labeling assistance information for training the positioning model. The network entity 1160 may include means for receiving, from the network node, a request for at least one of the second set of estimated positioning labels or the labeling assistance information. The network entity 1160 may include means for transmitting at least one of the second set of estimated positioning labels or the labeling assistance information in response to the request. The request may include an NRPPa message. The network entity 1160 may include means for transmitting the configuration for the set of SRSs in response to the request. The network entity 1160 may include an LMF. The network entity 1160 may include means for transmitting a request for at least one of the set of measured SRSs, the first set of estimated positioning labels, or the training associated information. The network entity 1160 may include means for receiving at least one of the set of measured SRSs, the first set of estimated positioning labels, or the training associated information in response to the request. The request may include an NRPPa message. The network entity 1160 may include means for the configuration may include an indication to measure at least one of (a) a TDoA associated with the set of SRSs, (b) an AoA associated with the set of SRSs, or (c) a multi-RTT associated with the set of SRSs. The network entity 1160 may include means for estimating the second set of estimated positioning labels based on at least one of the set of measured SRSs, the first set of estimated positioning labels, or the training associated information. The set of measured SRSs may include at least one of (a) an RTOA. (b) an RSRP, (c) an RSRPP, (d) an AoA, (c) an LOS identification, (f) a first probability of the RTOA, (g) a second probability of the RSRP. (h) a third probability of the RSRPP. (i) a fourth probability of the AoA, (j) a first range of the RTOA. (k) a second range of the RSRP, (l) a third range of the RSRPP, (m) a fourth range of the AoA, (n) a CIR, (o) a CFR, or (p) a PDP. The first set of estimated positioning labels may include at least one of (a) an RTOA, (b) an RSRP, (c) an RSRPP, (d) an AoA, (c) an LOS identification, (f) a first probability of the RTOA. (g) a second probability of the RSRP, (h) a third probability of the RSRPP, (i) a fourth probability of the AoA. (j) a first range of the RTOA, (k) a second range of the RSRP, (l) a third range of the RSRPP, (m) a fourth range of the AoA, (n) a CIR, (o) a CFR. (p) a PDP. (q) an indication of a location of the wireless device, or (r) a ToA. The network entity 1160 may include means for receiving the first set of estimated positioning labels by receiving, from the wireless device, a first subset of the first set of estimated positioning labels. The network entity 1160 may include means for receiving the first set of estimated positioning labels by receiving, from the network node, a second subset of the first set of estimated positioning labels. The labeling assistance information may include at least one of (a) a frame number associated with a subset of the set of estimated positioning labels, (b) a slot index associated with the subset of the set of estimated positioning labels, (c) an OFDM symbol associated with the subset of the set of estimated positioning labels, (d) a hyper frame number associated with the subset of the set of estimated positioning labels, or (c) an indication of a UTC timing associated with the subset of the set of estimated positioning labels. The training associated information may include at least one of (a) a frame number associated with the set of measured SRSs, (b) a slot index associated with the set of measured SRSs. (c) an orthogonal frequency-division multiplexing (OFDM) symbol associated with the set of measured SRSs, (d) a hyper frame number associated with the set of measured SRSs. (c) a first indication of a coordinated universal time (UTC) timing associated with the set of measured SRSs, (f) a second indication of a first location of the network node, (g) a third indication of a second location of a transmission reception point (TRP) associated with the network node, (h) a fourth indication of an implementation error, (i) a resource mapping associated with the set of SRSs, (j) a fifth indication of a label quality, (k) a sixth indication of a quality associated with at least one of the set of measured SRSs, or (l) a beam angle associated with the set of measured SRSs. The wireless device may include a UE or a PRU. The means may be the component 199 of the network entity 1160 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, may send the data to a device that transmits the data, or may send the data to another portion of the device, for example a positioning model training system. A device configured to “obtain” data, such as a transmission, signal, or message, may receive the data, for example with a transceiver, may obtain the data from a device that receives the data, or may obtain the data from another portion of the device, for example a positioning model training system. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network node, wherein the method comprises receiving a set of sounding reference signals (SRSs) from a wireless device. The method comprises measuring the set of SRSs. The method comprises outputting at least one of a set of estimated positioning labels, training associated information, or labeling assistance information associated with the set of measured SRSs for a positioning model.

Aspect 2 is the method of aspect 1, wherein outputting at least one of the set of estimated positioning labels, the training associated information, or the labeling assistance information comprises training the positioning model based on at least one of the set of estimated positioning labels, the training associated information, the labeling assistance information, or the set of measured SRSs.

Aspect 3 is the method of aspect 1, wherein outputting at least one of the set of estimated positioning labels, the training associated information, or the labeling assistance information comprises transmitting, to a network entity (or to another device for transmission to the network entity), at least one of the set of estimated positioning labels, the training associated information, or the set of measured SRSs for training the positioning model.

Aspect 4 is the method of aspect 3, wherein the network entity comprises a location management function (LMF).

Aspect 5 is the method of either of aspects 3 or 4, wherein the method comprises receiving, from the network entity, a request for at least one of the set of estimated positioning labels, the training associated information, or the set of measured SRSs, wherein the transmission of at least one of the set of estimated positioning labels, the training associated information, or the set of measured SRSs is in response to the request.

Aspect 6 is the method of aspect 5, wherein the request comprises a new radio (NR) positioning protocol (NRPP) annex (NRPPa) message.

Aspect 7 is the method of either of aspects 5 or 6, wherein the method comprises receiving a configuration for the set of SRSs associated with the request.

Aspect 8 is the method of aspect 7, wherein the configuration comprises an indication to measure at least one of (a) a time-difference of arrival (TDoA) associated with the set of SRSs. (b) an angle of arrival (AoA) associated with the set of SRSs, or (c) a multi-cell round trip time (multi-RTT) associated with the set of SRSs.

Aspect 9 is the method of any of aspects 1 to 8, wherein the method comprises estimating the set of estimated positioning labels based on at least one of the training associated information, the labeling assistance information, or the set of measured SRSs.

Aspect 10 is the method of any of aspects 1 to 9, wherein the set of measured SRSs comprises at least one of (a) a relative time of arrival (RTOA), (b) a reference signal received power (RSRP), (c) a reference signal received path power (RSRPP), (d) an angle of arrival (AoA), (e) a line-of-sight (LOS) identification, (f) a first probability of the RTOA, (g) a second probability of the RSRP. (h) a third probability of the RSRPP. (i) a fourth probability of the AoA. (j) a first range of the RTOA, (k) a second range of the RSRP. (l) a third range of the RSRPP. (m) a fourth range of the AoA, (n) a channel impulse response (CIR), (o) a channel frequency response (CFR), or (p) a power delay profile (PDP).

Aspect 11 is the method of any of aspects 1 to 10, wherein the set of estimated positioning labels comprises at least one of (a) a relative time of arrival (RTOA), (b) a reference signal received power (RSRP), (c) a reference signal received path power (RSRPP), (d) an angle of arrival (AoA), (e) a line-of-sight (LOS) identification, (f) a first probability of the RTOA. (g) a second probability of the RSRP. (h) a third probability of the RSRPP. (i) a fourth probability of the AoA. (j) a first range of the RTOA. (k) a second range of the RSRP. (l) a third range of the RSRPP. (m) a fourth range of the AoA. (n) a channel impulse response (CIR), (o) a channel frequency response (CFR), (p) a power delay profile (PDP), (q) an indication of a location of the wireless device, or (r) a time of arrival (ToA).

Aspect 12 is the method of any of aspects 1 to 11, wherein the method comprises receiving, from a network entity, at least one of the set of estimated positioning labels or the labeling assistance information.

Aspect 13 is the method of any of aspects 1 to 12, wherein the network entity comprises a location management function (LMF).

Aspect 14 is the method of either of aspects 12 or 13, wherein the method comprises transmitting, to the network entity (or to another device for transmission to the network entity), a request for at least one of the set of estimated positioning labels or the labeling assistance information, wherein the reception of at least one of the set of estimated positioning labels or the labeling assistance information is in response to the request.

Aspect 15 is the method of aspect 14, wherein the request comprises a new radio (NR) positioning protocol (NRPP) annex (NRPPa) message.

Aspect 16 is the method of either of aspects 14 or 15, wherein the method comprises receiving a configuration for the set of SRSs in response to the request.

Aspect 17 is the method of aspect 16, wherein the configuration comprises an indication to measure at least one of (a) a time-difference of arrival (TDoA) associated with the set of SRSs, (b) an angle of arrival (AoA) associated with the set of SRSs, or (c) a multi-cell round trip time (multi-RTT) associated with the set of SRSs.

Aspect 18 is the method of any of aspects 1 to 17, wherein the labeling assistance information comprises at least one of (a) a frame number associated with a subset of the set of estimated positioning labels, (b) a slot index associated with the subset of the set of estimated positioning labels, (c) an orthogonal frequency-division multiplexing (OFDM) symbol associated with the subset of the set of estimated positioning labels, (d) a hyper frame number associated with the subset of the set of estimated positioning labels, or (e) an indication of a coordinated universal time (UTC) timing associated with the subset of the set of estimated positioning labels.

Aspect 19 is the method of any of aspects 1 to 18, wherein the training associated information comprises at least one of (a) a frame number associated with the set of measured SRSs, (b) a slot index associated with the set of measured SRSs, (c) an orthogonal frequency-division multiplexing (OFDM) symbol associated with the set of measured SRSs. (d) a hyper frame number associated with the set of measured SRSs. (c) a first indication of a coordinated universal time (UTC) timing associated with the set of measured SRSs. (f) a second indication of a first location of the network node, (g) a third indication of a second location of a transmission reception point (TRP) associated with the network node, (h) a fourth indication of an implementation error, (i) a resource mapping associated with the set of SRSs. (j) a fifth indication of a label quality, (k) a sixth indication of a quality associated with at least one of the set of measured SRSs, or (l) a beam angle associated with the set of measured SRSs.

Aspect 20 is the method of any of aspects 1 to 19, wherein the wireless device comprises a user equipment (UE) or a positioning reference unit (PRU).

Aspect 21 is a method of wireless communication at a network entity, wherein the method comprises transmitting a configuration for a set of sounding reference signals (SRSs) from a wireless device to a network node. The method comprises receiving at least one of a set of measured SRSs, a first set of estimated positioning labels, or training associated information associated with the set of SRSs. The method comprises outputting at least one of a second set of estimated positioning labels, labeling assistance information, the set of measured SRSs, or the training associated information associated with the set of SRSs for a positioning model.

Aspect 22 is the method of aspect 21, wherein outputting at least one of the second set of estimated positioning labels, the labeling assistance information, the set of measured SRSs, or the training associated information comprises training the positioning model based on at least one of the second set of estimated positioning labels, the labeling assistance information, the set of measured SRSs, or the training associated information.

Aspect 23 is the method of aspect 21, wherein outputting at least one of the second set of estimated positioning labels, the labeling assistance information, the set of measured SRSs, or the training associated information comprises transmitting, to the network node (or to another device for transmission to the network node), at least one of the second set of estimated positioning labels or the labeling assistance information for training the positioning model.

Aspect 24 is the method of aspect 23, wherein the method comprises receiving, from the network node, a request for at least one of the second set of estimated positioning labels or the labeling assistance information, wherein the transmission of at least one of the second set of estimated positioning labels or the labeling assistance information is in response to the request.

Aspect 25 is the method of aspect 24, wherein the request comprises a new radio (NR) positioning protocol (NRPP) annex (NRPPa) message.

Aspect 26 is the method of either of aspects 24 or 25, wherein transmitting the configuration for the set of SRSs is in response to the request.

Aspect 27 is the method of any of aspects 21 to 26, wherein the network entity comprises a location management function (LMF).

Aspect 28 is the method of any of aspects 21 to 27, wherein the method comprises transmitting a request for at least one of the set of measured SRSs, the first set of estimated positioning labels, or the training associated information, wherein the reception of at least one of the set of measured SRSs, the first set of estimated positioning labels, or the training associated information is in response to the request.

Aspect 29 is the method of aspect 28, wherein the request comprises a new radio (NR) positioning protocol (NRPP) annex (NRPPa) message.

Aspect 30 is the method of any of aspects 21 to 29, wherein the configuration comprises an indication to measure at least one of (a) a time-difference of arrival (TDoA) associated with the set of SRSs, (b) an angle of arrival (AoA) associated with the set of SRSs, or (c) a multi-cell round trip time (multi-RTT) associated with the set of SRSs.

Aspect 31 is the method of any of aspects 21 to 30, wherein the method comprises estimating the second set of estimated positioning labels based on at least one of the set of measured SRSs, the first set of estimated positioning labels, or the training associated information.

Aspect 32 is the method of any of aspects 21 to 31, wherein the set of measured SRSs comprises at least one of (a) a relative time of arrival (RTOA), (b) a reference signal received power (RSRP), (c) a reference signal received path power (RSRPP), (d) an angle of arrival (AoA), (e) a line-of-sight (LOS) identification, (f) a first probability of the RTOA. (g) a second probability of the RSRP, (h) a third probability of the RSRPP. (i) a fourth probability of the AoA. (j) a first range of the RTOA, (k) a second range of the RSRP. (l) a third range of the RSRPP. (m) a fourth range of the AoA, (n) a channel impulse response (CIR), (o) a channel frequency response (CFR), or (p) a power delay profile (PDP).

Aspect 33 is the method of any of aspects 21 to 32, wherein the first set of estimated positioning labels comprises at least one of (a) a relative time of arrival (RTOA), (b) a reference signal received power (RSRP), (c) a reference signal received path power (RSRPP), (d) an angle of arrival (AoA), (e) a line-of-sight (LOS) identification, (f) a first probability of the RTOA, (g) a second probability of the RSRP. (h) a third probability of the RSRPP, (i) a fourth probability of the AoA. (j) a first range of the RTOA. (k) a second range of the RSRP. (l) a third range of the RSRPP, (m) a fourth range of the AoA. (n) a channel impulse response (CIR), (o) a channel frequency response (CFR), (p) a power delay profile (PDP), (q) an indication of a location of the wireless device, or (r) a time of arrival (ToA).

Aspect 34 is the method of aspect 33, wherein receiving the first set of estimated positioning labels comprises receiving, from the wireless device, a first subset of the first set of estimated positioning labels, wherein receiving the first set of estimated positioning labels comprises receiving, from the network node, a second subset of the first set of estimated positioning labels.

Aspect 35 is the method of any of aspects 21 to 34, wherein the labeling assistance information comprises at least one of (a) a frame number associated with a subset of the set of estimated positioning labels, (b) a slot index associated with the subset of the set of estimated positioning labels, (c) an orthogonal frequency-division multiplexing (OFDM) symbol associated with the subset of the set of estimated positioning labels, (d) a hyper frame number associated with the subset of the set of estimated positioning labels, or (e) an indication of a coordinated universal time (UTC) timing associated with the subset of the set of estimated positioning labels.

Aspect 36 is the method of any of aspects 21 to 35, wherein the training associated information comprises at least one of (a) a frame number associated with the set of measured SRSs. (b) a slot index associated with the set of measured SRSs, (c) an orthogonal frequency-division multiplexing (OFDM) symbol associated with the set of measured SRSs, (d) a hyper frame number associated with the set of measured SRSs, (e) a first indication of a coordinated universal time (UTC) timing associated with the set of measured SRSs. (f) a second indication of a first location of the network node, (g) a third indication of a second location of a transmission reception point (TRP) associated with the network node, (h) a fourth indication of an implementation error. (i) a resource mapping associated with the set of SRSs. (j) a fifth indication of a label quality, (k) a sixth indication of a quality associated with at least one of the set of measured SRSs, or (l) a beam angle associated with the set of measured SRSs.

Aspect 37 is the method of any of aspects 21 to 36, wherein the wireless device comprises a UE or a PRU.

Aspect 38 is an apparatus for wireless communication, including: a memory; and at least one processor coupled to the memory and, based at least in part on information stored in the memory, the at least one processor is configured to implement any of aspects 1 to 37.

Aspect 39 is the apparatus of aspect 38, further including at least one of an antenna or a transceiver coupled to the at least one processor.

Aspect 40 is an apparatus for wireless communication including means for implementing any of aspects 1 to 37.

Aspect 41 is a computer-readable medium (e.g., a non-transitory computer-readable medium) storing computer executable code, wherein the code, when executed by a processor, causes the processor to implement any of aspects 1 to 37.

What is claimed is:

1. An apparatus for wireless communication at a network node, comprising:
a memory; and
at least one processor coupled to the memory and, based at least in part on information stored in the memory, the at least one processor is configured to:
receive a set of sounding reference signals (SRSs) from a wireless device;
measure the set of SRSs; and
output at least one of a set of estimated positioning labels, training associated information, or labeling assistance information associated with the set of measured SRSs for a positioning model.

2. The apparatus of claim 1, wherein, to output at least one of the set of estimated positioning labels, the training associated information, or the labeling assistance information, the at least one processor is configured to:
train the positioning model based on at least one of the set of estimated positioning labels, the training associated information, the labeling assistance information, or the set of measured SRSs.

3. The apparatus of claim 1, wherein, to output at least one of the set of estimated positioning labels, the training associated information, or the labeling assistance information, the at least one processor is configured to:
transmit, to a network entity, at least one of the set of estimated positioning labels, the training associated information, or the set of measured SRSs for training the positioning model.

4. The apparatus of claim 3, wherein the network entity comprises a location management function (LMF).

5. The apparatus of claim 3, wherein the at least one processor is further configured to:
receive, from the network entity, a request for at least one of the set of estimated positioning labels, the training associated information, or the set of measured SRSs, wherein the transmission of at least one of the set of estimated positioning labels, the training associated information, or the set of measured SRSs is in response to the request.

6. The apparatus of claim 5, wherein the request comprises a new radio (NR) positioning protocol (NRPP) annex (NRPPa) message.

7. The apparatus of claim 5, wherein the at least one processor is further configured to:
receive a configuration for the set of SRSs associated with the request.

8. The apparatus of claim 7, wherein the configuration comprises an indication to measure at least one of:
a time-difference of arrival (TDoA) associated with the set of SRSs;
an angle of arrival (AoA) associated with the set of SRSs; or
a multi-cell round trip time (multi-RTT) associated with the set of SRSs.

9. The apparatus of claim 1, wherein the at least one processor is further configured to:
estimate the set of estimated positioning labels based on at least one of the training associated information, the labeling assistance information, or the set of measured SRSs.

10. The apparatus of claim 1, wherein the set of measured SRSs comprises at least one of:
a relative time of arrival (RTOA);
a reference signal received power (RSRP);
a reference signal received path power (RSRPP);
an angle of arrival (AoA);
a line-of-sight (LOS) identification;
a first probability of the RTOA;
a second probability of the RSRP;
a third probability of the RSRPP;
a fourth probability of the AoA;
a first range of the RTOA;
a second range of the RSRP;
a third range of the RSRPP;
a fourth range of the AoA;
a channel impulse response (CIR);
a channel frequency response (CFR); or
a power delay profile (PDP).

11. The apparatus of claim 1, wherein the set of estimated positioning labels comprises at least one of:
a relative time of arrival (RTOA);
a reference signal received power (RSRP);
a reference signal received path power (RSRPP);
an angle of arrival (AoA);
a line-of-sight (LOS) identification;
a first probability of the RTOA;
a second probability of the RSRP;
a third probability of the RSRPP;
a fourth probability of the AoA;
a first range of the RTOA;
a second range of the RSRP;
a third range of the RSRPP;
a fourth range of the AoA;
a channel impulse response (CIR);
a channel frequency response (CFR);
a power delay profile (PDP);
an indication of a location of the wireless device; or
a time of arrival (ToA).

12. The apparatus of claim 1, wherein the at least one processor is further configured to:
receive, from a network entity, at least one of the set of estimated positioning labels or the labeling assistance information.

13. The apparatus of claim 12, wherein the at least one processor is configured to:
transmit, to the network entity, a request for at least one of the set of estimated positioning labels or the labeling assistance information, wherein the reception of at least one of the set of estimated positioning labels or the labeling assistance information is in response to the request.

14. The apparatus of claim 13, wherein the request comprises a new radio (NR) positioning protocol (NRPP) annex (NRPPa) message.

15. The apparatus of claim 13, wherein the at least one processor is further configured to:
receive a configuration for the set of SRSs in response to the request.

16. The apparatus of claim 15, wherein the configuration comprises an indication to measure at least one of:
a time-difference of arrival (TDoA) associated with the set of SRSs;
an angle of arrival (AoA) associated with the set of SRSs; or
a multi-cell round trip time (multi-RTT) associated with the set of SRSs.

17. The apparatus of claim 1, wherein the labeling assistance information comprises at least one of:
a frame number associated with a subset of the set of estimated positioning labels;
a slot index associated with the subset of the set of estimated positioning labels;
an orthogonal frequency-division multiplexing (OFDM) symbol associated with the subset of the set of estimated positioning labels;
a hyper frame number associated with the subset of the set of estimated positioning labels; or
an indication of a coordinated universal time (UTC) timing associated with the subset of the set of estimated positioning labels.

18. The apparatus of claim 1, wherein the training associated information comprises at least one of:
a frame number associated with the set of measured SRSs;
a slot index associated with the set of measured SRSs;
an orthogonal frequency-division multiplexing (OFDM) symbol associated with the set of measured SRSs;
a hyper frame number associated with the set of measured SRSs;
a first indication of a coordinated universal time (UTC) timing associated with the set of measured SRSs;
a second indication of a first location of the network node;
a third indication of a second location of a transmission reception point (TRP) associated with the network node;
a fourth indication of an implementation error;
a resource mapping associated with the set of SRSs;
a fifth indication of a label quality;
a sixth indication of a quality associated with at least one of the set of measured SRSs; or
a beam angle associated with the set of measured SRSs.

19. The apparatus of claim 1, wherein the wireless device comprises a user equipment (UE) or a positioning reference unit (PRU).

20. The apparatus of claim 1, further comprising a transceiver coupled to the at least one processor, wherein to receive the set of SRSs, the at least one processor is configured to:
receive, via the transceiver, the set of SRSs from the wireless device.

21. An apparatus for wireless communication at a network entity, comprising:
a memory; and
at least one processor coupled to the memory and, based at least in part on information stored in the memory, the at least one processor is configured to:
transmit a configuration for a set of sounding reference signals (SRSs) from a wireless device to a network node;
receive at least one of a set of measured SRSs, a first set of estimated positioning labels, or training associated information associated with the set of SRSs; and
output at least one of a second set of estimated positioning labels, labeling assistance information, the set of measured SRSs, or the training associated information associated with the set of SRSs for a positioning model.

22. The apparatus of claim 21, wherein, to output at least one of the second set of estimated positioning labels, the labeling assistance information, the set of measured SRSs, or the training associated information, the at least one processor is configured to:
train the positioning model based on at least one of the second set of estimated positioning labels, the labeling assistance information, the set of measured SRSs, or the training associated information.

23. The apparatus of claim 21, further comprising a transceiver coupled to the at least one processor, wherein, to output at least one of the second set of estimated positioning labels, the labeling assistance information, the set of measured SRSs, or the training associated information, the at least one processor is configured to:
transmit, via the transceiver to the network node, at least one of the second set of estimated positioning labels or the labeling assistance information for training the positioning model.

24. The apparatus of claim 23, wherein the at least one processor is further configured to:
receive, from the network node, a request for at least one of the second set of estimated positioning labels or the labeling assistance information, wherein the transmission of at least one of the second set of estimated positioning labels or the labeling assistance information is in response to the request.

25. The apparatus of claim 21, wherein the at least one processor is further configured to:
transmit a request for at least one of the set of measured SRSs, the first set of estimated positioning labels, or the training associated information, wherein the reception of at least one of the set of measured SRSs, the first set of estimated positioning labels, or the training associated information is in response to the request.

26. The apparatus of claim 21, wherein the at least one processor is further configured to:
estimate the second set of estimated positioning labels based on at least one of the set of measured SRSs, the first set of estimated positioning labels, or the training associated information.

27. The apparatus of claim 21, wherein the first set of estimated positioning labels comprises at least one of:
a relative time of arrival (RTOA);
a reference signal received power (RSRP);
a reference signal received path power (RSRPP);
an angle of arrival (AoA);
a line-of-sight (LOS) identification;
a first probability of the RTOA;
a second probability of the RSRP;
a third probability of the RSRPP;
a fourth probability of the AoA;
a first range of the RTOA;
a second range of the RSRP;
a third range of the RSRPP;
a fourth range of the AoA;
a channel impulse response (CIR);
a channel frequency response (CFR);
a power delay profile (PDP);
an indication of a location of the wireless device; or
a time of arrival (ToA).

28. The apparatus of claim 27, wherein, to receive the first set of estimated positioning labels, the at least one processor is configured to:
receive, from the wireless device, a first subset of the first set of estimated positioning labels; or
receive, from the network node, a second subset of the first set of estimated positioning labels.

29. A method of wireless communication at a network node, comprising:
receiving a set of sounding reference signals (SRSs) from a wireless device;
measuring the set of SRSs; and
outputting at least one of a set of estimated positioning labels, training associated information, or labeling assistance information associated with the set of measured SRSs for a positioning model.

30. A method of wireless communication at a network entity, comprising:
transmitting a configuration for a set of SRSs from a wireless device to a network node;
receiving at least one of a set of measured sounding reference signals (SRSs), a first set of estimated positioning labels, or training associated information associated with the set of SRSs; and
outputting at least one of a second set of estimated positioning labels, labeling assistance information, the set of measured SRSs, or the training associated information associated with the set of SRSs for a positioning model.
